(19) United States
(12) Patent Application Publication
(10) Pub. No.: US 2026/0267583 A1
(43) Pub. Date: Sep. 10, 2026

(54) MANAGING OUTPUT OF CONTENT

(71) Applicant: Apple Inc., Cupertino, CA (US)

(72) Inventors: Jessica J. PECK BROWN, Morgan Hill, CA (US); Corey Wang, Costa Mesa, CA (US)

(21) Appl. No.: 19/531,458

(22) Filed: Feb. 5, 2026

Related U.S. Application Data
(60) Provisional application No. 63/976,625, filed on Feb. 5, 2026.
(60) Provisional application No. 63/755,243, filed on Feb. 6, 2025.

(51) Int. Cl. G06F 3/14; G06F 3/16

(52) U.S. Cl. CPC G06F 3/14; G06F 3/165

(57) ABSTRACT

Some techniques are for outputting an indication that the content is in another area in accordance with some embodiments. Other techniques are for causing output of content at different locations in accordance with some embodiments. Other techniques are for causing output of complimentary content in accordance with some embodiments. Other techniques are for outputting content related to other content in accordance with some embodiments.

### CROSS-REFERENCE TO RELATED APPLICATIONS

This application claims priority to U.S. Provisional Patent Application Serial No. 63/755,243, entitled “Managing Output of Content” filed Feb. 06, 2025, and U.S. Provisional Patent Application Serial No. 63/976,625, entitled “Managing Output of Content” filed Feb. 05, 2026, which are hereby incorporated by reference in their entirety for all purposes.

### BACKGROUND

Electronic devices often output content. Outputting content often includes the output of content across various devices.

### SUMMARY

Some techniques described herein enable electronic devices to be faster, more efficient, and/or more effective for outputting content. Such techniques can replace and/or work in conjunction with existing techniques for outputting content.

In some embodiments, a method that is performed at a first computer system that is in communication with one or more output devices is described. In some embodiments, the method comprises: while outputting, via the one or more output devices, content, receiving an indication that a subject caused output of the content on a second computer system different from the first computer system; and in response to receiving the indication that the subject caused output of the content on the second computer system: in accordance with a determination that the indication corresponds to a first area of an environment, outputting, via the one or more output devices, an indication of the first area of the environment; and in accordance with a determination that the indication corresponds to a second area of the environment, outputting, via the one or more output devices, an indication of the second area of the environment, wherein the second area is different from the first area.

In some embodiments, a non-transitory computer-readable storage medium storing one or more programs configured to be executed by one or more processors of a first computer system that is in communication with one or more output devices is described. In some embodiments, the one or more programs includes instructions for: while outputting, via the one or more output devices, content, receiving an indication that a subject caused output of the content on a second computer system different from the first computer system; and in response to receiving the indication that the subject caused output of the content on the second computer system: in accordance with a determination that the indication corresponds to a first area of an environment, outputting, via the one or more output devices, an indication of the first area of the environment; and in accordance with a determination that the indication corresponds to a second area of the environment, outputting, via the one or more output devices, an indication of the second area of the environment, wherein the second area is different from the first area.

In some embodiments, a transitory computer-readable storage medium storing one or more programs configured to be executed by one or more processors of a first computer system that is in communication with one or more output devices is described. In some embodiments, the one or more programs includes instructions for: while outputting, via the one or more output devices, content, receiving an indication that a subject caused output of the content on a second computer system different from the first computer system; and in response to receiving the indication that the subject caused output of the content on the second computer system: in accordance with a determination that the indication corresponds to a first area of an environment, outputting, via the one or more output devices, an indication of the first area of the environment; and in accordance with a determination that the indication corresponds to a second area of the environment, outputting, via the one or more output devices, an indication of the second area of the environment, wherein the second area is different from the first area.

In some embodiments, a first computer system that is configured to communicate with one or more output devices is described. In some embodiments, the first computer system comprises one or more processors and memory storing one or more programs configured to be executed by the one or more processors. In some embodiments, the one or more programs includes instructions for: while outputting, via the one or more output devices, content, receiving an indication that a subject caused output of the content on a second computer system different from the first computer system; and in response to receiving the indication that the subject caused output of the content on the second computer system: in accordance with a determination that the indication corresponds to a first area of an environment, outputting, via the one or more output devices, an indication of the first area of the environment; and in accordance with a determination that the indication corresponds to a second area of the environment, outputting, via the one or more output devices, an indication of the second area of the environment, wherein the second area is different from the first area.

In some embodiments, a first computer system that is configured to communicate with one or more output devices is described. In some embodiments, the first computer system comprises means for performing each of the following steps: while outputting, via the one or more output devices, content, receiving an indication that a subject caused output of the content on a second computer system different from the first computer system; and in response to receiving the indication that the subject caused output of the content on the second computer system: in accordance with a determination that the indication corresponds to a first area of an environment, outputting, via the one or more output devices, an indication of the first area of the environment; and in accordance with a determination that the indication corresponds to a second area of the environment, outputting, via the one or more output devices, an indication of the second area of the environment, wherein the second area is different from the first area.

In some embodiments, a computer program product is described. In some embodiments, the computer program product comprises one or more programs configured to be executed by one or more processors of a first computer system that is in communication with one or more output devices. In some embodiments, the one or more programs include instructions for: while outputting, via the one or more output devices, content, receiving an indication that a subject caused output of the content on a second computer system different from the first computer system; and in response to receiving the indication that the subject caused output of the content on the second computer system: in accordance with a determination that the indication corresponds to a first area of an environment, outputting, via the one or more output devices, an indication of the first area of the environment; and in accordance with a determination that the indication corresponds to a second area of the environment, outputting, via the one or more output devices, an indication of the second area of the environment, wherein the second area is different from the first area.

In some embodiments, a method that is performed at a first computer system that is in communication with one or more input devices is described. In some embodiments, the method comprises: detecting, via the one or more input devices, an input that corresponds to a subject; and in response to detecting the input that corresponds to the subject: in accordance with a determination that the subject most recently interacted with a second computer system at a first location, causing output of content at the first location, wherein the second computer system is different from the first computer system; and in accordance with a determination that the subject most recently interacted with a third computer system at a second location, causing output of the content at the second location, wherein the third computer system is different from the first computer system and the second computer system, and wherein the second location is different from the first location.

In some embodiments, a non-transitory computer-readable storage medium storing one or more programs configured to be executed by one or more processors of a first computer system that is in communication with one or more input devices is described. In some embodiments, the one or more programs includes instructions for: detecting, via the one or more input devices, an input that corresponds to a subject; and in response to detecting the input that corresponds to the subject: in accordance with a determination that the subject most recently interacted with a second computer system at a first location, causing output of content at the first location, wherein the second computer system is different from the first computer system; and in accordance with a determination that the subject most recently interacted with a third computer system at a second location, causing output of the content at the second location, wherein the third computer system is different from the first computer system and the second computer system, and wherein the second location is different from the first location.

In some embodiments, a transitory computer-readable storage medium storing one or more programs configured to be executed by one or more processors of a first computer system that is in communication with one or more input devices is described. In some embodiments, the one or more programs includes instructions for: detecting, via the one or more input devices, an input that corresponds to a subject; and in response to detecting the input that corresponds to the subject: in accordance with a determination that the subject most recently interacted with a second computer system at a first location, causing output of content at the first location, wherein the second computer system is different from the first computer system; and in accordance with a determination that the subject most recently interacted with a third computer system at a second location, causing output of the content at the second location, wherein the third computer system is different from the first computer system and the second computer system, and wherein the second location is different from the first location.

In some embodiments, a first computer system that is configured to communicate with one or more input devices is described. In some embodiments, the first computer system comprises one or more processors and memory storing one or more programs configured to be executed by the one or more processors. In some embodiments, the one or more programs includes instructions for: detecting, via the one or more input devices, an input that corresponds to a subject; and in response to detecting the input that corresponds to the subject: in accordance with a determination that the subject most recently interacted with a second computer system at a first location, causing output of content at the first location, wherein the second computer system is different from the first computer system; and in accordance with a determination that the subject most recently interacted with a third computer system at a second location, causing output of the content at the second location, wherein the third computer system is different from the first computer system and the second computer system, and wherein the second location is different from the first location.

In some embodiments, a first computer system that is configured to communicate with one or more input devices is described. In some embodiments, the first computer system comprises means for performing each of the following steps: detecting, via the one or more input devices, an input that corresponds to a subject; and in response to detecting the input that corresponds to the subject: in accordance with a determination that the subject most recently interacted with a second computer system at a first location, causing output of content at the first location, wherein the second computer system is different from the first computer system; and in accordance with a determination that the subject most recently interacted with a third computer system at a second location, causing output of the content at the second location, wherein the third computer system is different from the first computer system and the second computer system, and wherein the second location is different from the first location.

In some embodiments, a computer program product is described. In some embodiments, the computer program product comprises one or more programs configured to be executed by one or more processors of a first computer system that is in communication with one or more input devices. In some embodiments, the one or more programs include instructions for: detecting, via the one or more input devices, an input that corresponds to a subject; and in response to detecting the input that corresponds to the subject: in accordance with a determination that the subject most recently interacted with a second computer system at a first location, causing output of content at the first location, wherein the second computer system is different from the first computer system; and in accordance with a determination that the subject most recently interacted with a third computer system at a second location, causing output of the content at the second location, wherein the third computer system is different from the first computer system and the second computer system, and wherein the second location is different from the first location.

In some embodiments, a method that is performed at a first computer system is described. In some embodiments, the method comprises: while a second computer system outputs first content: detecting an attention of a subject; in response to detecting the attention of the subject: in accordance with a determination that the attention of the subject is directed at a third computer system, causing the third computer system to output second content that is complementary to the first content, wherein the third computer system is different from the first computer system and the second computer system; and in accordance with a determination that the attention of the subject is directed at a fourth computer system, causing the fourth computer system to output third content that is complimentary to the first content, wherein the fourth computer system is different from the first computer system, the second computer system, and the third computer system.

In some embodiments, a non-transitory computer-readable storage medium storing one or more programs configured to be executed by one or more processors of a first computer system is described. In some embodiments, the one or more programs includes instructions for: while a second computer system outputs first content: detecting an attention of a subject; in response to detecting the attention of the subject: in accordance with a determination that the attention of the subject is directed at a third computer system, causing the third computer system to output second content that is complementary to the first content, wherein the third computer system is different from the first computer system and the second computer system; and in accordance with a determination that the attention of the subject is directed at a fourth computer system, causing the fourth computer system to output third content that is complimentary to the first content, wherein the fourth computer system is different from the first computer system, the second computer system, and the third computer system.

In some embodiments, a transitory computer-readable storage medium storing one or more programs configured to be executed by one or more processors of a first computer system is described. In some embodiments, the one or more programs includes instructions for: while a second computer system outputs first content: detecting an attention of a subject; in response to detecting the attention of the subject: in accordance with a determination that the attention of the subject is directed at a third computer system, causing the third computer system to output second content that is complementary to the first content, wherein the third computer system is different from the first computer system and the second computer system; and in accordance with a determination that the attention of the subject is directed at a fourth computer system, causing the fourth computer system to output third content that is complimentary to the first content, wherein the fourth computer system is different from the first computer system, the second computer system, and the third computer system.

In some embodiments, a first computer system is described. In some embodiments, the first computer system comprises one or more processors and memory storing one or more programs configured to be executed by the one or more processors. In some embodiments, the one or more programs includes instructions for: while a second computer system outputs first content: detecting an attention of a subject; in response to detecting the attention of the subject: in accordance with a determination that the attention of the subject is directed at a third computer system, causing the third computer system to output second content that is complementary to the first content, wherein the third computer system is different from the first computer system and the second computer system; and in accordance with a determination that the attention of the subject is directed at a fourth computer system, causing the fourth computer system to output third content that is complimentary to the first content, wherein the fourth computer system is different from the first computer system, the second computer system, and the third computer system.

In some embodiments, a first computer system is described. In some embodiments, the first computer system comprises means for performing each of the following steps: while a second computer system outputs first content: detecting an attention of a subject; in response to detecting the attention of the subject: in accordance with a determination that the attention of the subject is directed at a third computer system, causing the third computer system to output second content that is complementary to the first content, wherein the third computer system is different from the first computer system and the second computer system; and in accordance with a determination that the attention of the subject is directed at a fourth computer system, causing the fourth computer system to output third content that is complimentary to the first content, wherein the fourth computer system is different from the first computer system, the second computer system, and the third computer system.

In some embodiments, a computer program product is described. In some embodiments, the computer program product comprises one or more programs configured to be executed by one or more processors of a first computer system. In some embodiments, the one or more programs include instructions for: while a second computer system outputs first content: detecting an attention of a subject; in response to detecting the attention of the subject: in accordance with a determination that the attention of the subject is directed at a third computer system, causing the third computer system to output second content that is complementary to the first content, wherein the third computer system is different from the first computer system and the second computer system; and in accordance with a determination that the attention of the subject is directed at a fourth computer system, causing the fourth computer system to output third content that is complimentary to the first content, wherein the fourth computer system is different from the first computer system, the second computer system, and the third computer system.

In some embodiments, a method that is performed at a computer system is described. In some embodiments, the method comprises: receiving a request to output first content on a set of one or more devices; and in response to receiving the request to output the first content on the set of one or more devices: in accordance with a determination that a first device of the set of one or more devices satisfies a set of one or more criteria with respect to output of the first content, causing the first device of the set of one or more devices to output second content related to the first content; and in accordance with a determination that a second device of the set of one or more devices satisfies the set of one or more criteria with respect to output of the first content, causing the second device of the set of one or more devices to output the second content related to the first content, wherein the first device is different from the second device.

In some embodiments, a non-transitory computer-readable storage medium storing one or more programs configured to be executed by one or more processors of a computer system is described. In some embodiments, the one or more programs includes instructions for: receiving a request to output first content on a set of one or more devices; and in response to receiving the request to output the first content on the set of one or more devices: in accordance with a determination that a first device of the set of one or more devices satisfies a set of one or more criteria with respect to output of the first content, causing the first device of the set of one or more devices to output second content related to the first content; and in accordance with a determination that a second device of the set of one or more devices satisfies the set of one or more criteria with respect to output of the first content, causing the second device of the set of one or more devices to output the second content related to the first content, wherein the first device is different from the second device.

In some embodiments, a transitory computer-readable storage medium storing one or more programs configured to be executed by one or more processors of a computer system is described. In some embodiments, the one or more programs includes instructions for: receiving a request to output first content on a set of one or more devices; and in response to receiving the request to output the first content on the set of one or more devices: in accordance with a determination that a first device of the set of one or more devices satisfies a set of one or more criteria with respect to output of the first content, causing the first device of the set of one or more devices to output second content related to the first content; and in accordance with a determination that a second device of the set of one or more devices satisfies the set of one or more criteria with respect to output of the first content, causing the second device of the set of one or more devices to output the second content related to the first content, wherein the first device is different from the second device.

In some embodiments, a computer system is described. In some embodiments, the computer system comprises one or more processors and memory storing one or more programs configured to be executed by the one or more processors. In some embodiments, the one or more programs includes instructions for: receiving a request to output first content on a set of one or more devices; and in response to receiving the request to output the first content on the set of one or more devices: in accordance with a determination that a first device of the set of one or more devices satisfies a set of one or more criteria with respect to output of the first content, causing the first device of the set of one or more devices to output second content related to the first content; and in accordance with a determination that a second device of the set of one or more devices satisfies the set of one or more criteria with respect to output of the first content, causing the second device of the set of one or more devices to output the second content related to the first content, wherein the first device is different from the second device.

In some embodiments, a computer system is described. In some embodiments, the computer system comprises means for performing each of the following steps: receiving a request to output first content on a set of one or more devices; and in response to receiving the request to output the first content on the set of one or more devices: in accordance with a determination that a first device of the set of one or more devices satisfies a set of one or more criteria with respect to output of the first content, causing the first device of the set of one or more devices to output second content related to the first content; and in accordance with a determination that a second device of the set of one or more devices satisfies the set of one or more criteria with respect to output of the first content, causing the second device of the set of one or more devices to output the second content related to the first content, wherein the first device is different from the second device.

In some embodiments, a computer program product is described. In some embodiments, the computer program product comprises one or more programs configured to be executed by one or more processors of a computer system. In some embodiments, the one or more programs include instructions for: receiving a request to output first content on a set of one or more devices; and in response to receiving the request to output the first content on the set of one or more devices: in accordance with a determination that a first device of the set of one or more devices satisfies a set of one or more criteria with respect to output of the first content, causing the first device of the set of one or more devices to output second content related to the first content; and in accordance with a determination that a second device of the set of one or more devices satisfies the set of one or more criteria with respect to output of the first content, causing the second device of the set of one or more devices to output the second content related to the first content, wherein the first device is different from the second device.

A computer-readable storage medium or other computer program product that is set up to run on one or more processors can optionally include executable instructions for carrying out steps described above.

### DESCRIPTION OF THE DRAWINGS

To gain a clearer understanding of techniques described herein, references to various embodiments are described below in the Detailed Description. In conjunction with the Detailed Description, drawings are provided in which reference numerals refer to related parts across the drawings.

FIG. 1 is a block diagram illustrating a computer system in accordance with some embodiments.

FIG. 2A is a block diagram illustrating a device and a system in accordance with some embodiments.

FIG. 2B illustrates a computer system with a touch screen in accordance with some embodiments.

FIG. 3 is a block diagram illustrating an ecosystem including a computer system with other accessory devices in accordance with some embodiments.

FIGS. 4A-4G illustrate exemplary user interfaces for outputting content in accordance with some embodiments.

FIG. 5 is a flow diagram illustrating a process for outputting an indication that the content is in another area in accordance with some embodiments.

FIG. 6 is a flow diagram illustrating a process for causing output of content at different locations in accordance with some embodiments.

FIG. 7 is a flow diagram illustrating a process for causing output of complimentary content in accordance with some embodiments.

FIG. 8 is a flow diagram illustrating a process for outputting content related to other content in accordance with some embodiments.

### DETAILED DESCRIPTION

The description that follows covers exemplary embodiments and examples. However, it should be acknowledged that this description is given as an explanation and is not meant to restrict the scope of the current disclosure. For example, terms used to describe different embodiments and different examples are not meant to be restrictive unless explicitly stated.

In some embodiments, one or more steps of a process can be contingent upon fulfillment of one or more conditions. To fulfill the one or more conditions, a process can be repeated multiple times. In such embodiments, different conditions can be satisfied in different repetitions. For example, steps can be repeated until all conditions have been satisfied. In some embodiments, electronic devices, computer systems, and/or computer readable mediums include instructions for performing one or more steps that are contingent upon one or more conditions being satisfied. Such instructions can include logic that determines whether the one or more conditions have been fulfilled without repetition of a step.

Although terms such as “first”, “second”, and so forth are used with different elements in the following description, these elements should not be constrained by the terms unless explicitly stated otherwise. In some embodiments, the terms are used to differentiate one element from another. For example, a “first” input can be different from a “second” input, though the terms “first” and “second” can be switched without changing the meaning of either input. In some embodiments, the “first” input and the “second” input are two different references to the same input unless explicitly stated otherwise.

Unless context makes it apparent otherwise, singular forms of “a”, “an”, and “the” are meant to cover plural forms. Additionally, the term “and/or” is meant to be interpreted to apply to and include any and all potential combinations of one or more of the related mentioned things. The terms “has”, “having”, “includes”, “including”, “comprises”, and/or “comprising” are meant to cover the presence of different elements; however, they do not preclude the presence or addition of one or more additional elements. The term “if” is meant to be interpreted to indicate “when”, “upon”, “in response to determining”, or “in response to detecting”. Accordingly, depending on the context, the expressions “if it is determined” or “if [a stated condition] is detected” can be interpreted as meaning “upon determining”, “in response to determining”, “upon detecting [the stated condition]”, or “in response to detecting [the stated condition]”.

Some processes described below enhance the operability of devices and make interfaces better, such as by helping a user provide proper inputs and/or reduce mistakes when using devices, through various techniques. For example, some processes perform an operation when a set of conditions has been met without requiring further input, such as input by a user. For another example, some processes provide additional control options without cluttering user interfaces with additional displayed controls. For another example, some processes reduce the number of inputs needed to perform an operation. For another example, some processes provide improved feedback (e.g., visual, haptic, acoustic, and/or tactile feedback) to a user. Additional techniques include increasing the security and/or privacy of the device and/or reducing burn-in. These techniques also reduce power usage and/or improve battery life of devices, such as by enabling a user to use devices better, more quickly, and/or efficiently.

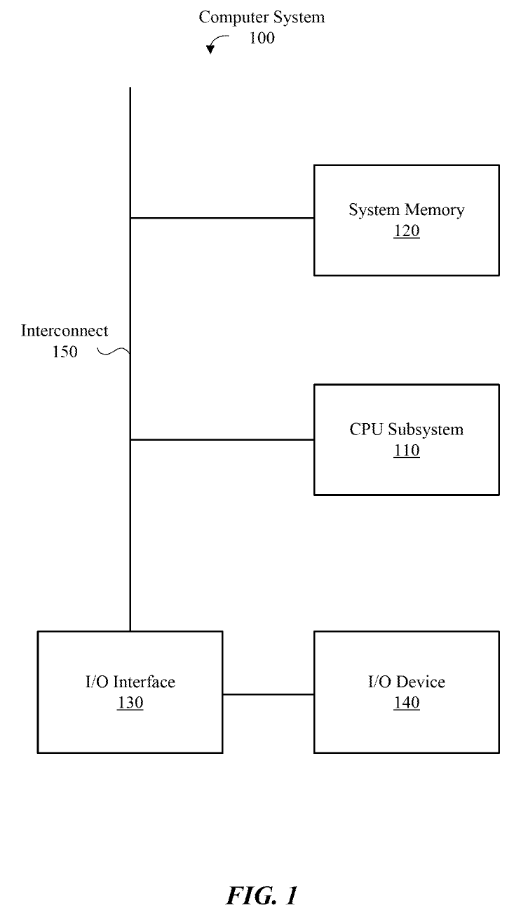

Below, FIGS. 1, 2A-2B and 3 provide description of exemplary devices for implementing techniques described below.

FIG. 1 is a block diagram illustrating a computer system in accordance with some embodiments. While FIG. 1 illustrates one computer system, two or more computer systems working together can implement techniques described herein. It should be acknowledged that the computer system (e.g., computer system 100) is sometimes referred to as a device, an electronic device, an electronic system, a compute system, and/or a system. In some embodiments, computer system 100 is a personal computer system, a server system, a smart phone, a system on a chip, a smart watch, a wearable device, a tablet, a laptop computer, a fitness tracking device, a head-mounted display (HMD) device, a desktop computer, a communal device (e.g., a smart speaker, connected thermostat, and/or other home-based computer systems), an accessory (e.g., a switch, light, speaker, air conditioner, heater, window cover, fan, lock, media playback device, and/or television), a controller, a hub device, or a sensor.

As illustrated in FIG. 1, computer system 100 includes CPU subsystem 110, system memory 120, and I/O interface 130. Such components are able to communicate with one another through interconnect 150. In some embodiments, interconnect 150 is an electrical means of communication such as a system bus, one or more memory locations, and/or additional electrical channels for connecting multiple components of computer system 100.

It should be acknowledged that computer system 100 is only one example of a computer system to carry out techniques described below and that one or more other computer systems can carry out such techniques. Furthermore, while FIG. 1 illustrates a particular computer architecture of computer system 100, techniques described herein can be carried out by other computer architectures, such as by incorporating more, less, similar, and/or different components than the components illustrated.

In some embodiments, CPU subsystem 110 includes one or more processing units that can carry out techniques described herein. For example, CPU subsystem 110 can execute system-level and/or application-level instructions to perform an operation. In some embodiments, computer system 100 has several processing subsystems (e.g., multiple instances of CPU subsystem 110).

In some embodiments, CPU subsystem 110 is capable of carrying out instructions stored on a storage medium, such as a non-transitory or transitory computer-readable medium. A computer-readable storage medium (or many physical computer-readable storage media of one or more types) including one or more computer-readable instructions can be used to realize implementations falling partially or fully under the purview of the current disclosure. It should be acknowledged that computer-readable instructions can be arranged in any way, such as components, software, processes, widgets, and/or applications.

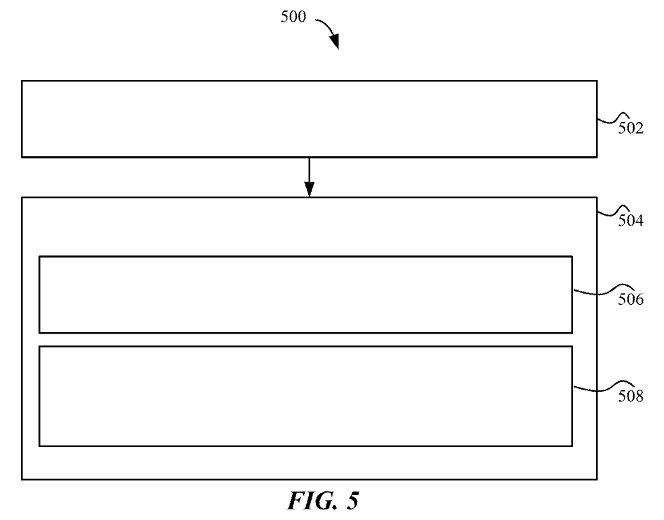

It should be acknowledged that the storage medium can be any medium that can physically include or store computer-executable instructions. For example, the storage medium can be temporary or non-temporary. Examples of storage medium include magnetic (e.g., hard drives and/or magnetic disks), optical (e.g., optical drives and/or optical discs based on CD, DVD, and Blu-ray technologies), solid state (e.g., solid state drives and/or flash drives), and/or semiconductor (e.g., random access memory) storages. In some embodiments, the storage medium is system memory 120. In such embodiments, each instruction stored by system memory 120 and executed by CPU subsystem 110 corresponds to an operation for completing functionality described herein. For example, instructions for processes 500, 600, 700, and 800 (FIGS. 5-8) can be stored in system memory 120.

In some embodiments, system memory 120 implements a range of distinct physical, non-transitory memory media. Examples of system memory 120 include a storage array, a storage area network (SAN), a removable flash drive, flash memory, hard disk storage, optical drive storage, floppy disk storage, removable disk storage, random access memory (such as SDRAM, DDR SDRAM, RAM-SRAM, EDO RAM, and/or RAMBUS RAM), and/or read-only memory (such as PROM and/or EEPROM). In some embodiments, computer system 100 has several memory components coupled, either directly or via interconnect 150, to CPU subsystem 110.

In some embodiments, computer system 100 communicates with external devices through I/O interface 130, which can be one or more types of interfaces. For example, I/O interface 130 can include a bridge chip that connects a front-side bus to one or more back-side buses. In some embodiments, I/O interface 130 allows communication through one or more appropriate buses or other interfaces with one or more I/O devices, such as I/O device 140. For example, I/O device 140 can include one or more: physical user-interface devices (e.g., a physical keyboard, a mouse, a button, a touch-sensitive surface, a rotatable component, and/or a joystick), storage devices (e.g., as described above with respect to system memory 120), network interface devices (e.g., to a local and/or wide-area network), sensor devices (e.g., a camera, a microphone, a motion detector, and/or a temperature sensor), audio output devices (e.g., speaker, audio jacks, and/or hearing loops), and/or visual output devices (e.g., screen, light, and/or projector). In some embodiments, I/O device 140 includes a network interface device that enables computer system 100 to establish a wired or wireless connection to a network or other computer systems. Examples of network interface devices include Ethernet, USB, Bluetooth, NFC, Wi-Fi, and/or Thunderbolt communication devices. In some embodiments, I/O device 140 is wired or wirelessly connected to I/O interface 130.

In some embodiments, a component of computer system 100 incorporates I/O device 140 with other components. For example, a single component can include I/O interface 130 and I/O device 140. In some embodiments, I/O device 140 is a discrete component, meaning it is not incorporated into another part of computer system 100. In some embodiments, functionality of different components is integrated into a component of computer system 100 that is composed of I/O interface 130 and I/O device 140. Additionally, it should be acknowledged that computer system 100 can include one or more I/O interfaces that connect to one or more I/O devices.

In some embodiments, I/O device 140 can be used to detect a subject (e.g., a user, a person, an animal, another computer system different from computer system 100, and/or an object) and/or an input (e.g., a verbal input, a tap input, a swipe input, a hold-and-drag input, a gaze input, an air-gesture input, a physical input and/or a passive input) from a detected subject. In some embodiments, a user has an account enabled by and/or linked to computer system 100, and computer system 100 can determine if a detected subject is a user with an account (e.g., a known user). Determining if a detected subject has an account includes identifying and/or authenticating the detected subject. In some embodiments, identifying and/or authenticating the detected subject includes comparing detected information to stored information about known users. For example, comparing detected information can include comparing biometric data (e.g., facial scans, iris scans, fingerprint scans, and/or voice recognition data) of detected subjects to stored biometric data of known users. For another example, comparing detected information can include comparing detected identification (e.g., MAC address and/or IP address) of a computer system of a detected subject to known identifications of computer systems of known users. For yet another example, comparing detected information can include comparing detected passcodes (e.g., usernames, passwords, passphrases, and/or PINs). In another example, computer system 100 can detect a known user (e.g., a user that corresponds to an account) and allow access to an environment when the user is identified. In some embodiments, computer system 100 detects unknown subjects and enables guest accounts for the unknown subjects to utilize computer system 100.

In some embodiments, computer system 100 collects information without the need for physical inputs via a sensor of I/O device 140. For example, computer system 100 can recognize subject inputs, including air-gesture inputs and/or passive inputs via a camera. In some embodiments, an air-gesture input is that is a detected intentional motion of a portion of the subject’s body without the subject touching an input element in communication with or of the device. In some embodiments, a passive input is a detected input that is not purposefully directed at computer system 100 and/or a component in communication with computer system 100. Examples of passive inputs that can be detected by a camera include, but are not limited to, the subject entering an environment, the motion of the subject through an environment, the location of the subject in the environment, the direction the subject is looking and/or facing, and/or light levels of the environment. In some embodiments, computer system 100 can send visual and/or video data to an application from one or more cameras. For example, computer system 100 can send video data to an application for the purpose of making a video phone call. For another example, computer system 100 can detect the sound of a subject talking, glass breakings, and/or music playing via a microphone of I/O device 140. In some embodiments, computer system 100 recognizes speech as verbal a input from a subject that are detected via a microphone.

In some embodiments, computer system 100 detects information about the environment via other types of sensors of I/O device 140. Examples of such sensors include a flow sensor, a gas sensor, a humidity sensor, a chemical sensor, a contact sensor, a precipitation sensor, a pressure sensor, a proximity sensor, a motion sensor, an occupancy sensor, an electricity sensor, and/or a flood sensor.

In some embodiments, computer system 100 detects a physical input via a physical user-interface device of I/O device 140 that allow a subject to communicate with computer system 100 directly. In some embodiments, computer system 100 includes one or more input devices as described above, and data from one input device is combined with data from one or more other input devices (e.g., that are a part of computer system 100 and/or other computer systems) to gather information about the physical environment.

In some embodiments, computer system 100 outputs visual information via a component of I/O device 140, such as a display screen, a projector, a touch-sensitive display, and/or a light. For example, I/O device 140 can include a light to indicate a status of computer system 100, such as an on/off status. For another example, I/O device 140 can include a display screen for displaying user interface elements. In some embodiments, “outputting” visual information includes sending data (e.g., image and/or video data) to an external display component via a wired or wireless connection, causing the external display component can display the visual information.

In some embodiments, computer system 100 emits sound via an audio output device of I/O device 140, such as a speaker, a headphone, an earbud, an audio jack, an optical audio output, a Bluetooth audio output, an HDMI audio output, and/or a hearing loop. For example, computer system 100 can provide a subject with information and/or audio-based content via speakers of I/O device 140.

In some embodiments, I/O device 140 includes a tactile output device. For example, I/O device 140 can include a haptic element that allows computer system 100 to communicate with a subject who is in close proximity to or in physical contact with computer system 100.

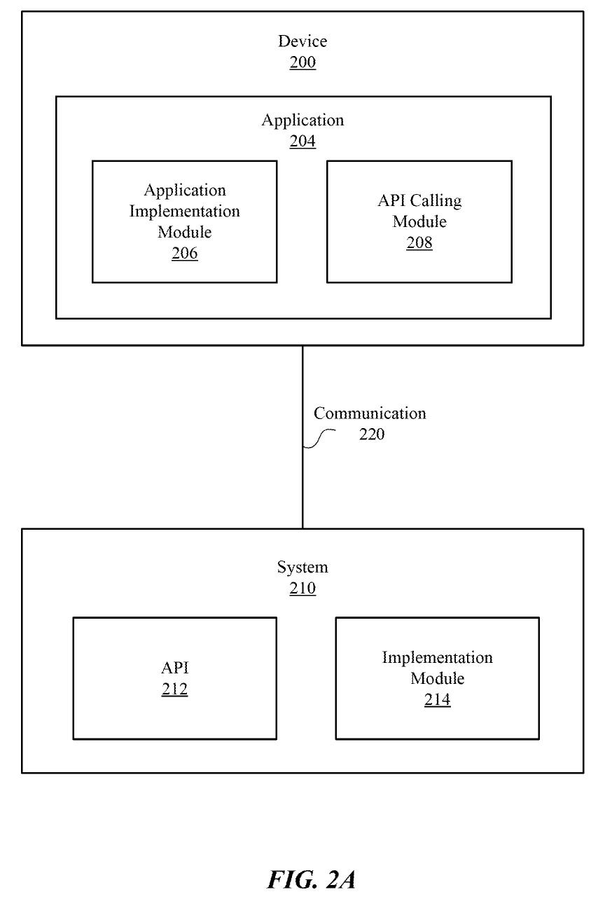

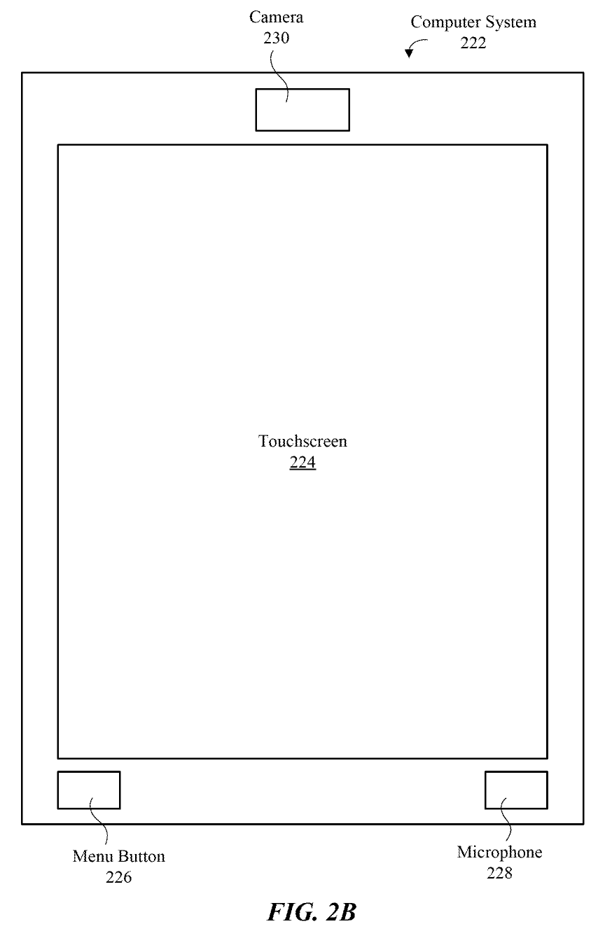

FIG. 2A is a block diagram illustrating a device and a system in accordance with some embodiments. In some embodiments, device 200 is a personal computing device, a server system, a smart phone, a smart watch, a tablet, a laptop computer, a fitness tracking device, a head-mounted display (HMD) device, a desktop computer, a communal device (e.g., a smart speaker, connected thermostat, and/or other home-based computer systems), an accessory (e.g., a switch, light, speaker, air conditioner, heater, window cover, fan, lock, media playback device, and/or television), a controller, a hub device, or a sensor. In some embodiments, system 210 is an operating system hosted on device 200. In some embodiments, system 210 is an operating system hosted on an external device (e.g., a server, a peripheral device, an accessory, and/or a personal computing device). It should be acknowledged that device 200 and/or system 210 can include more, fewer, and/or different components than illustrated in FIG. 2A.

As illustrated in FIG. 2A, device 200 includes an application (e.g., application 204) that, when executed by one or more processing units, causes device 200 to perform one or more processes and/or methods described herein. In some embodiments, application 204 is an application that is pre-installed on device 200 by a manufacture of device 200 (e.g., a first-party application). In some embodiments, application 204 is an application that is provided to device 200 via an operating system update file (e.g., a first-party application or a second-party application). In some embodiments, application 204 is an application that is installed by a user of device 200, such as through an application store installed on device 200. It should be acknowledged that application 204 can be any suitable type of application such a browser application, a fitness application, a health application, a digital payments application, a media application, a social network application, a messaging application, a maps application, and/or an application that functions as an execution environment for plug-ins, widgets and/or other applications. In some embodiments, application 204 causes device 200 to perform processes 500, 600, 700, and 800 (FIGS. 5-8).

In some embodiments, a software platform has a set of frameworks that provide objects and/or behaviors that a software developer uses to build applications on the software platform. Software developers use the set of frameworks to display and/or interact with content, and/or manage interactions with the software platform. In some embodiments, an application relies on the set of frameworks for their behavior. In such embodiments, the set frameworks can provide different ways for the software developer to customize behavior of the application to match specific needs of the application.

In some embodiments, interaction with a device includes transfer and/or receipt of one or more API calls between multiple different software processes (e.g., different portions of an operating system, an application and an operating system, or different applications) via one or more APIs. For example, when an input is detected, raw sensor data can be processed into one or more input events that are provided (e.g., via an API) to a receiving software process that makes some determination based on the one or more input events, and then sends (e.g., via an API) information to a software process to perform an operation (e.g., change a device state and/or user interface).

In some embodiments, an object and/or a behavior is accessed via an API, specifying a format for communication between processes, including specifying and grouping available protocols, variables, and/or functions. For example, an API call, sometimes referred to as an API request, can be sent from a first software process to a second software process as a way to accomplish different things. The first software process can request information from the second software process. The first software process can provide information to the second software process. The first software process can request action by the second software process. The first software process can provide information to the second software process about action taken by the first software process.

In some embodiments, while a determination and an operation performed in response can be made by the same software process, alternatively, a determination can be made in a first software process and relayed (e.g., via an API) to a second software process different from the first software process. Relaying the determination can cause an operation to be performed by the second software process. Alternatively, the second software process can relay one or more instructions (e.g., via an API) to a third software process different from the first software process and/or the second software process. The one nor more instructions can be to perform an operation.

It should be acknowledged that some or all subject interactions with a computer system can involve one or more API calls within a step of interacting with the computer system, such as between different software components of the computer system or between a software component of the computer system and a software component of one or more remote computer systems.

As illustrated in FIG. 2A, application 204 includes application implementation module 206 and API calling module 208. In some embodiments, application implementation module 206 includes a set of one or more instructions corresponding to one or more operations performed by application 204. For example, when application 204 is a messaging application, application implementation module 206 can include operations to receive and send messages.

In some embodiments, API calling module 208 is a module that can receive application programming interface (API) calls, respond to API calls, and/or send API calls. In some embodiments, application implementation module 206 communicates with API calling module 208 to communicate with a system, such as system 210. In some embodiments, communication 220 represents one or more API calls and/or one or more other forms of communication between device 200 (e.g., one or more components of device 200) and system 210 (e.g., one or more components of system 210).

As illustrated in FIG. 2A, system 210 includes API 212 and implementation module 214. In some embodiments, API 212 is a software and/or hardware module that can receive API calls, respond to API calls, and/or send API calls. In some embodiments, API 212 is a software module (e.g., a collection of computer-readable instructions) that provides an interface that allows a different module (e.g., API calling module 208) to access and/or use one or more functions, methods, procedures, data structures, classes, and/or other services provided by implementation module 214. For example, API calling module 208 can make an API call to API 212 to access and use a feature of implementation module 214 that is specified by API 212. In some embodiments, API 212 is implemented in part by firmware, microcode, or other low-level logic that executes in part on the hardware component.

In some embodiments, API calling module 208 passes data and/or controls information within implementation module 214 through the one or more API calls via API 212. In some embodiments, API 212 includes one or more features for translating API calls and returns between implementation module 214 and API calling module 208, which allows multiple API-calling modules written in different programming languages to communicate with implementation module 214. For example, API calling module 208 can call using APIs from different providers such as a set of APIs from an OS provider, another set of APIs from a plug-in provider, and/or another set of APIs from another provider (e.g., the provider of a software library) or creator of the other set of APIs.

In some embodiments, implementation module 214 is a system (e.g., operating system, and/or server system) software module that is constructed to perform an operation in response to receiving an API call via API 212. In some embodiments, implementation module 214 is constructed to provide an API response (via API 212) as a result of processing an API call. In some embodiments, implementation module 214 is embodied at least in part in firmware, microcode, or hardware logic. In some embodiments, implementation module 214 calls one or more other components via an underlying API and thus is both an implementation module and an API calling module similar to API calling module 208. For example, implementation module 214 and API calling module 208 can each be any one of an operating system, a library, a device driver, an API, an application program, or other module. It should be acknowledged that implementation module 214 and API calling module 208 can be the same or different type of module from each other.

In some embodiments, various API calls are transferred between API calling module 208 and implementation module 214. It should be acknowledged that transferring API calls can include issuing, initiating, invoking, calling, receiving, returning, and/or responding to a function of calls or messages. In other words, transferring API calls can describe actions by either API calling module 208 or implementation module 214. In some embodiments, in response to an API call from API calling module 208, implementation module 214 returns (via API 212) a value to report to application 204 the capabilities or state of a hardware component of device 200, such as input capabilities and state, output capabilities and state, processing capability, power state, storage capacity and state, and/or communications capability.

In some embodiments, implementation module 214 provides more than one API, with different APIs supplying different aspects of functionality performed by implementation module 214 while protecting some aspects of functionality from view. For example, one API of implementation module 214 can provide a first set of functions and can be exposed to third-party developers while another API of implementation module 214 can be hidden (e.g., not exposed) and provide a subset of the first set of functions and/or provide a different set of functions, such as testing or debugging functions which are not in the first set of functions. It should be acknowledged that implementation module 214 can include additional functions, methods, classes, data structures, and/or other features that are not specified through API 212 and are not available to API calling module 208. In some embodiments, implementation module 214, API 212, and/or API calling module 208 are stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, in response to and/or after receiving information from one or more hardware components of device 200, one or more software modules of device 200, and/or one or more hardware components external to device 200 (e.g., a peripheral device, an accessory device, and/or a server), application 204 executes a task with the information. In some embodiments, the tasks executed include: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling API 212 of system 210 based on the information. In some embodiments, after receiving the information, application 204 executes the task in response to a trigger, such as a detection of an event, a notification received from system 210, an input, and/or a response to a call to an API provided by system 210.

In some embodiments, application 204 calling API 212 (e.g., as part of a task executed by application 204 in response to and/or after receiving information) includes using one or more parameters defined by API 212. In some embodiments, the one or more parameters include a constant, a key, a data structure, an object, an object class, a variable, a data type, a pointer, an array, a list or a pointer to a function or method, and/or another way to reference a data or other item to be passed via API 212.

In some embodiments, in response to and/or after receiving the information, application 204 transfers the information to system 210 via communication 220. In some embodiments, after receiving the information, application 204 transfers the information to system 210 in response to a trigger.

FIG. 2B illustrates a computer system with a touch screen in accordance with some embodiments. In some embodiments, computer system 222 is a portable multifunction device that is a personal device of a user. It should be acknowledged that computer system 222 can be computer system 100 and/or device 200 as described above.

As illustrated in FIG. 2B, computer system 222 includes touch screen 224, touch screen 230, menu button 226, and microphone 228. In some embodiments, computer system 222 displays, via touch screen 224, a user interface (UI) including one or more user interface elements, such as controls, graphics, and/or content. Computer system 222 can then detect an input, such as a tap input using a finger of a user or a stylus, on a user interface element to select the user interface element. In some embodiments, the user interface element is selected when touch screen 223 no longer detects the input.

In some embodiments, microphone 228 is an input device for detecting sounds near computer system 222, including verbal inputs from a user. For example, computer system 222 can detect a subject making a verbal request and/or command to computer system 222 via microphone 228. In some embodiments, computer system 222 collects data and/or information about a subject via microphone 228. For example, computer system 222 can confirm an identity of a subject by matching a verbal input of the subject to a voice profile of a user. At FIG. 2B, microphone 228 is part of computer system 222. In some embodiments, microphone 228 is not part of but is in communication (e.g., via a wired and/or wireless communication) with computer system 222.

In some embodiments, camera 230 is an input device that includes an image or video sensor (such as one or more optical sensors and/or one or more depth sensors) that allows computer system 222 to detect objects and/or inputs (e.g., hand and/or air-gesture inputs) near computer system 222. In some embodiments, computer system 222 collects data and/or information about a subject via camera 230. For example, computer system 222 can confirm an identity a subject by matching a facial scan of a subject to a biometric profile of a user. At FIG. 2B, camera 230 is part of computer system 222. In some embodiments, camera 230 is not part of computer system 222 but is in communication (e.g., via a wired and/or wireless connection) with computer system 222. In some embodiments, camera 230 is always on and continuously capturing images (e.g., periodically and/or without interruption). In some embodiments, camera 230 begins to capture an image when an input and/or interaction is detected.

In some embodiments, menu button 226 is a physical button that, when depressed, provides a physical input for computer system 222. In some embodiments, touch screen 224 and/or menu button 226 are used for turning computer system 222 on and off and/or locking it. For example, menu button 226 can be used to lock computer system 222 by pressing and releasing menu button 226 before a predetermined amount of time (e.g., 2-10 seconds) has passed. For another example, menu button 226 can be used to unlock computer system 222 or start an unlocking process, or to turn computer system 222 on or off by pressing and holding menu button 226 in the depressed state for longer than the predetermined amount of time. In some embodiments, microphone 228 allows computer system 222 to detect a verbal input for turning on or off certain features. Additionally, computer system 222 can optionally have one or more tactile output devices to provide tactile outputs (e.g., haptic outputs) to the user and/or one or more contact intensity sensors to detect the intensity of contacts on touch screen 224

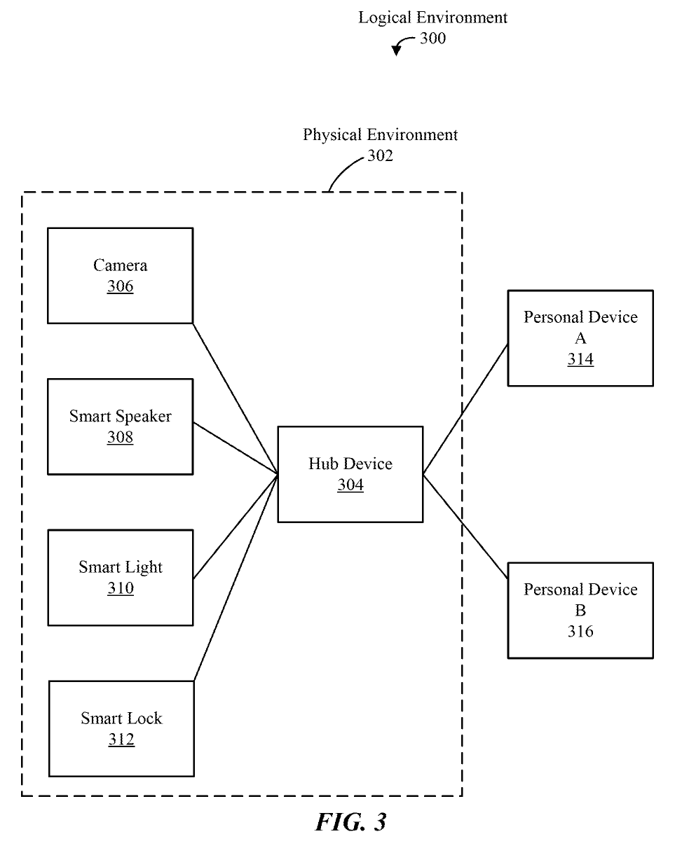

FIG. 3 is a block diagram illustrating a logical environment in accordance with some embodiments. As illustrated in FIG. 3, logical environment 300 includes multiple devices that are in communication (e.g., wired and/or wirelessly) with each other. In some embodiments, logical environment 300 is a software-defined construct that represents state, capabilities, and/or permissible interactions of devices within logical environment 300. For example, logical environment 300 can maintain a data model including (1) unique identifiers for different devices and/or assigned roles for each device, (2) a capability map describing supported functions and/or data formats, (3) a relationship graph indicating pairing status, hierarchy, and/or authorized communication paths, (4) contextual state parameters such as operating modes, user profiles, and/or session data, and/or (5) policy constraints that govern security, power management, and/or permissible commands. In some embodiments, logical environment 300 enables controller devices (e.g., hub device 304, personal device A 314, and/or personal device B 316) to discover, address, control, and/or configure accessory devices (e.g., camera 306, smart speaker 308, smart light 310, smart lock 312, and/or hub device 304). In such embodiments, logical environment 300 can be independent of underlying physical transports and/or physical location. In some embodiments, logical environment 300 includes a server. In such embodiments, a server is a remotely accessible digital storage system capable of communicating with devices within logical environment 300.

As illustrated in FIG. 3, logical environment 300 includes (e.g., involves) devices within physical environment 302 (e.g., camera 306, smart speaker 308, smart light 310, smart lock 312, and hub device 304). In some embodiments, physical environment 302 is a physical location, such a home, an office building, a warehouse, and/or an apartment building. It should be acknowledged that techniques described herein can be used with any type of physical location.

In some embodiments, the devices within logical environment 300 work together using one or more of the techniques described herein for detecting an activity in, interacting with, capturing sensor data related to, and/or communicating data about physical environment 302. Such control and/or communication can be via a homeowner and/or administrator of physical environment 302 and/or logical environment 300. In some embodiments, detecting an activity includes detecting and/or identifying a subject within physical environment 302. In some embodiments, in response to detecting the activity, a device (e.g., camera 306, smart speaker 308, smart light 310, smart lock 312, and/or hub device 304) within physical environment 302 captures sensor data in physical environment 302 and/or performs an operation. In such embodiments, the operation can includes allowing or denying a subject access to all or part of physical environment 302, turning on a light, and/or playing music.

At FIG. 3, devices illustrated within the dashed box of physical environment 302 are located within physical environment 302. Such devices include hub device 304, camera 306, smart speaker 308, smart light 310, and smart lock 312. In some embodiments, such devices and are in communication via one or more local area networks (e.g., Wi-Fi and/or ethernet), one or more personal area network (e.g., Bluetooth, Zigbee, and/or Thread), one or more wide area networks (e.g., Internet and/or cellular), and/or one or more peer-to-peer connections.

At FIG. 3, devices illustrated outside the dashed box of physical environment 302 are located outside of physical environment 302 or are mobile with the ability to be inside or outside of physical environment 302. Such devices include personal device A 314 and personal device B 316. It should be acknowledged that logical environment 300 and physical environment 302 are described for explanatory purposes and that techniques described below can be carried out with more, less, similar, and/or different devices than the devices and/or the configurations discussed above.

In some embodiments, hub device 304 is a stationary or semi-stationary computer system that communicates with accessory devices located within physical environment 302 including, but not limited to, camera 306, smart speaker 308, smart light 310 and/or smart lock 312. In some embodiments, hub device 304 communicates with one or more accessory devices on behalf of (e.g., communicates information to and/or from) one or more controller devices, such as personal device A 314 and/or personal device B 316. In some embodiments, hub device 304 provides centralized coordination, routing, and/or persistent data storage for physical environment 302. In some embodiments, hub device 304 includes a component for detecting other devices, such as a camera, a microphone, and/or Bluetooth and/or Ultra-Wideband (UWB) component. While hub device 304 is depicted in FIG. 3 as a single device, the functionality described below can be implemented with two or more resident devices operating together. Examples of hub device 304 include a smart speaker, a set-top box, a router, a home-automation bridge, a television, and/or a desktop computer.

In some embodiments, hub device 304 communicates with devices outside of physical environment 302. For example, hub device 304 can communicate with other hub devices that belong to different environments. For another example, hub device 304 can communicate with other accessory devices and/or other controller devices. In such embodiments, hub device 304 communicates with other devices through one or more communication channels described above (e.g., a local area network, a personal area network, a peer-to-peer connection, and/or a wide area network).

In some embodiments, hub device 304 includes and/or is in communication with one or more cameras with which hub device 304 can capture an image and/or a video of a subject and/or activity within physical environment 302. In some embodiments, hub device 304 includes and/or is in communication with one or more microphones with which hub device 304 can detect noise (e.g., glass breaking, an alarm going off, and/or a subject talking) within physical environment 302. In some embodiments, a microphone enables hub device 304 to detect verbal inputs from a subject, enabling the subject to interact with hub device 304 without making physical contact with hub device 304 or another computer system within physical environment 302.

In some embodiments, hub device 304 includes and/or is in communication with one or more sensors. In some embodiments, a sensor includes a hardware component capable of detecting (e.g., sensing and/or processing) information about physical environment 302 in proximity to the hardware component. For example, a sensor can be configured to detect information surrounding the sensor, detect information in one or more directions away from the sensor, and/or detect information based on contact of the sensor with an element of physical environment 302. In some embodiments, a hardware component of a sensor includes a sensing component (e.g., a temperature and/or image sensor), a transmitting component (e.g., a radio transmitter and/or laser transmitter), and/or a receiving component (e.g., a radio receiver and/or laser receiver). It should be acknowledged that a sensor can be multiple types of sensors. For example, a sensor can be an angle sensor, a breakage sensor, a flow sensor, a force sensor, a gas sensor, a humidity or moisture sensor, a glass breakage sensor, a chemical sensor, a contact sensor, a non-contact sensor, an image sensor (e.g., a RGB camera and/or an infrared sensor), a particle sensor, a photoelectric sensor (e.g., ambient light and/or solar), a position sensor (e.g., a global positioning system), a precipitation sensor, a pressure sensor, a proximity sensor, a radiation sensor, an inertial measurement unit, a leak sensor, a level sensor, a metal sensor, a motion sensor, a range or depth sensor (e.g., RADAR and/or LiDAR), a speed sensor, a temperature sensor, a time-of-flight sensor, a torque sensor, and an ultrasonic sensor, a vacancy sensor, a presence sensor, a voltage and/or current sensor, a conductivity sensor, a resistivity sensor, a capacitive sensor, and/or a water sensor. In some embodiments, hub device 304 combines data from multiple sensors to generate information about physical environment 302.

In some embodiments, hub device 304 includes and/or is in communication with one or more speakers that can output audio content into physical environment 302. In some embodiments, hub device 304 includes and/or is in communication with one or more display component, such as a display, a projector, a touch-sensitive display, a head-mounted display (HMD), and/or another device component that presents visual content to a subject. In some embodiments, hub device 304 includes and/or is in communication with a touch-sensitive surface (such as a touchpad or a touch screen display) from which hub device 304 detects inputs.

In some embodiments, camera 306 is a computer system for capturing and/or recording images in the form of digital photos and/or videos. In some embodiments, camera 306 includes and/or is in communication with one or more sensors, such as those mentioned above with respect to hub device 304. In some embodiments, camera 306 captures an image and/or a video continuously and/or in response to detecting an activity via a sensor. In some embodiments, camera 306 combines data from multiple sensors (e.g., that are part of camera 306 and/or one or more additional devices in communication with camera 306) to generate information about physical environment 302. While camera 306 is presented as an individual device, it should be acknowledged that camera 306 can represent multiple devices capable of capturing images and/or videos. For example, camera 306 can include cameras positioned to observe important areas of physical environment 302, such as an entrance, a hallway, and/or a living room area.

In some embodiments, smart speaker 308 is a computer system that converts electrical signals into sound and includes one or more components for outputting audio, such as speakers, audio distributors, soundbars, headphones, earphones, earbuds, television speakers, HMD speakers, audio jacks, optical audio outputs, Bluetooth audio outputs, and/or HDMI audio outputs. For example, smart speaker 308 can output audio content to provide information to a subject. In some embodiments, smart speaker 308 includes one or more microphones that can be used by smart speaker 308 to obtain data and/or information from a subject and/or about physical environment 302. For example, smart speaker 308 can detect if a subject is in the room by detecting a subject talking via a microphone. In some embodiments, the information that smart speaker 308 obtains via the microphone includes verbal inputs from a subject. For example, a subject can request smart speaker 308 to perform an action and/or obtain information for the subject. While smart speaker 308 is presented as an individual device, it should be acknowledged that smart speaker 308 can represent multiple devices capable of outputting audio.

In some embodiments, smart light 310 is a computer system for outputting light and includes one or more components for outputting light, such as an incandescent, LED, fiber optic, fluorescent, halogen, and/or neon light. In some embodiments, smart light 310 includes and/or is in communication with one or more sensors, such as those mentioned above with respect to hub device 304. In some embodiments, smart light 310 outputs light or ceases outputting light in response to detecting an activity via a sensor. For example, smart light 310 can turn on in response to detecting a sound via a microphone. For another example, smart light 310 can turn off in response to detecting light from another light source via a light sensor. While smart light 310 is presented as an individual device, it should be acknowledged that smart light 310 can represent multiple devices capable of outputting light.

In some embodiments, smart lock 312 is a computer system for locking and unlocking an area and includes one or more components for such locking, such as a deadbolt, mortise, electromagnet, and/or latch lock. In some embodiments, smart lock 312 includes and/or is in communication with one or more sensors, such as those mentioned above with respect to hub device 304, and locks or unlocks in response to detecting an activity via a sensor. For example, smart lock 312 can lock in response to detecting a contact sensor close, indicating that a door has closed. In some embodiments, smart lock 312 includes and/or is in communication with an input component capable of detecting physical inputs, such as a physical input mechanism (e.g., one or more buttons) and/or a touch sensitive surface and/or screen, and locks or unlocks in response to detecting inputs via the input component. For example, smart lock 312 can unlock in response to detecting a correct PIN code being entered via the input component. In some embodiments, smart lock 312 includes a component for detecting other devices, such as Bluetooth, UWB, and/or Near Field Communication (NFC) component, and locks or unlocks in response to detecting another device. For example, smart lock 312 can unlock in response to detecting, via UWB, a personal device of a user approach smart lock 312. While smart lock 312 is presented as an individual device, it should be acknowledged that smart lock 312 can represent multiple devices capable of locking and unlocking areas.

Personal device A 314 and personal device B 316 are computer systems belonging to users and/or groups of users. For example, personal device A 314 and/or personal device B 316 can be a smart phone, a tablet, a smart watch, a laptop, a communal device, a personal gaming system, a desktop computer, a fitness tracking device, and/or an HMD. In some embodiments, personal device A 314 and personal device B 316 are the same type of device. For example, both personal device A 314 and personal device B 316 can both be smart phones. In other embodiments, personal device A 314 and personal device B 316 are different types of devices. For example, personal device A 314 can be a smartwatch while personal device B 316 can be a smart phone.

In some embodiments, one or more devices within logical environment 300 communicate with hub device 304 about an activity detected within physical environment 302. For example, in response to unlocking, smart lock 312 can communicate the unlocking to hub device 304. In some embodiments, in response to a device communicating a detected activity, hub device 304 captures a photo and/or a video of physical environment 302 (e.g., via camera 306 and/or a camera of hub device 304). For example, in response to smart speaker 308 communicating about detecting a noise, hub device 304 can send a command to camera 306 to capture video of physical environment 302 near smart speaker 308. In some embodiments, one or more devices within logical environment 300 send information (e.g., images, video, audio, inputs and/or status updates from sensors) regarding an activity to hub device 304 and, in response, hub device 304 analyzes the information. For example, when camera 306 captures a video in response to detecting motion (e.g., as discussed above), camera 306 can send the video to hub device 304 to analyze. For example, hub device 304 can analyze a captured image of physical environment 302 that includes smoke and determine a fire is in physical environment 302.

In some embodiments, devices outside of hub device 304 analyze data to make determination. For example, camera 306 can determine an identity of a subject within an image and send the identity to hub device 304 rather than sending the image. For another example, in response to smart lock 312 detecting the presence of a personal device of a user (e.g., personal device A 314), hub device 304 can request camera 306 to capture an image. After capturing the image, camera 306 can identify a subject in the image to determine whether the image includes the user.

In some embodiments, after a subject is identified (e.g., such as using camera 306 as described above), hub device 304 initiates an authentication process to authenticate the subject. The authentication process can verify and/or confirm the identity of the subject in physical environment 302. For example, if the subject is registered with hub device 304, in conjunction with identifying the subject (e.g., via camera 306 as described above), hub device 304 communicates with a personal device (e.g., personal device A 314 or personal device B 316) registered to the subject through wireless signal (e.g., UWB signal, Bluetooth signal, and/or Wi-Fi signal) to authenticate the subject. In some embodiments, hub device 304 captures and/or receives multiple types of information at once and is able to identify and authenticate the subject simultaneously. For example, in a scenario where the subject in physical environment 302 is speaking while being within the field-of-view of camera 306, hub device 304 can identify the subject using an image captured via camera 306 using facial recognition and authenticate the subject using audio captured via smart speaker 308 to match voice biometrics. In some embodiments, hub device 304 receives an authentication key (e.g., PIN code and/or key fob authenticator) for a user (such as when the user enters the authentication key at smart lock 312) and uses the fact that the authentication key corresponds to same user as detected in physical environment 302 via another device, such as camera 306, to authenticate the user.

In some embodiments, when a subject is identified and not authenticated, hub device 304 sends an authentication request to a personal device (e.g., personal device A 314 or personal device B 316) of the subject. For example, hub device 304 can send a request for a facial scan and/or a PIN to personal device A 314, and consider the subject authenticated upon receiving a notification from personal device 412 that correct information has been entered and/or received. In some embodiments, hub device 304 sends an authentication request to a personal device detected within physical environment 302.

In some embodiments, personal device B 316 is a personal device (e.g., phone, watch and/or tablet) belonging to an administrator (e.g., a resident, owner, and/or caretaker) of logical environment 300. Personal device B 316 can be in communication with hub device 304 and allow the administrator to view and/or remotely control aspects of logical environment 300, such as managing camera views and/or visitor access. In some embodiments, in response to detecting an inquiry (e.g., “Who is at the door?” and/or “Is anyone home?”), personal device B 316 sends a request to hub device 304 to capture an image (e.g., via camera 306) and send the image to personal device B 316. It should be acknowledged that communication between devices within physical environment 302 and personal device B 316 can occur even when personal device B 316 is outside physical environment 302, such as through a secure outside internet or cellular connection.

In some embodiments, hub device 304 sends a notification to personal device B 316 in response to detecting (e.g., directly and/or via another device of ecosystem 400) an activity. For example, hub device 304 can send a notification to personal device B 316 in response to not being able to identify a subject detected in physical environment 302. In some embodiments, the notification sent by hub device 304 to personal device B 316 includes information corresponding to a time and/or a location that the activity and/or subject was detected. In some embodiments, the notification includes an image and/or a video of the activity. For example, the notification can include a video of smoke filling a room where smoke was detected. In some embodiments, the notification includes identifying information (e.g., name, photo, and/or video) of the subject in physical environment 302. In some embodiments, hub device 304 sends a notification without sending images to personal device B 316. For example, an administrator might want to be notified if someone they recognize is at the front door without showing a video feed of a camera at the front door. For another example, the notification might not require an image, such as a notification that a thermostat has detected a temperature outside of a predetermined range. In other embodiments, hub device 304 does not send a notification if certain identified subjects are detected, thus avoiding unnecessary notifications (e.g., an administrator might not care to be notified if their spouse or roommate is detected at the front door).

In some embodiments, the notification sent by hub device 304 to personal device B 316 includes an option to authenticate a detected subject via the notification (e.g., a control within the notification and/or an application corresponding the notification). In some embodiments, if the detected subject is identified, the notification includes a control to initiate communication (e.g., text and/or call) with the detected subject. In some embodiments, the notification includes a control to initiate communication with a subject detected in physical environment 302 via smart speaker 308. In some embodiments, the notification includes escalation options such as a control contacting emergency services. In some embodiments, the administrator corresponding to personal device B 316 creates a profile for a subject in physical environment 302 that automatically authenticates the subject.

In some embodiments, devices within physical environment 302 output content to communicate information to a subject within physical environment 302. For example, in response to a subject being identified but not authenticated, hub device 304 can output via smart speaker 308 a request for the subject to authenticate themselves. For another example, in response to detecting a door being opened, hub device 304 can indicate the door is opened by outputting light via smart light 310 near the door. In some embodiments, devices within physical environment 302 output content to communicate an event escalation. For example, in response to personal device B 316 detecting an input on the control to contact emergency services (e.g., as described above), smart light 310 can flash its lights and smart speaker 308 can output alarm noises.

In some embodiments, hub device 304 allows communication with administrators of logical environment 300. For example, a person in physical environment 302 can request to call an administrator of logical environment 300 (e.g., initiate a call to personal device B 316) to request access to physical environment 302 and/or devices within physical environment 302. In some embodiments, hub device 304 detect such a request directly or via an input on a personal device (e.g., personal device A 314). In such embodiments, the administrator can give allowance to subject in physical environment 302 and personal device B 316 communicates to hub device 304 that the subject in physical environment 302 has been authenticated.

In some embodiments, after the subject in physical environment 302 is identified and authenticated, hub device 304 enables the subject access to physical environment 302 and/or one or more devices with physical environment 302. In some embodiments, hub device 304 enables the subject access to physical environment 302s for a predefined amount of time (e.g., 1 hour to 10 days). In such embodiments, the predefined amount of time can vary depending on the type of authorization provided to the subject. For example, a guest of physical environment 302 can have access for less time than a temporary resident of physical environment 302.

In some embodiments, data about activities detected within physical environment 302 is recorded and stored. Some or all of such activity data can be stored locally (e.g., via hub device 304) and/or remotely (e.g., via a server). Storing activity data can allow an administrator of physical environment 302 to review a history of activity in physical environment 302.

Reference is made herein to environmental context (also referred to herein as a “context of an environment” and/or “a context corresponding to an environment”). In some embodiments, an environmental context is a context based on one or more characteristics of physical environment 302 (e.g., subjects, locations, time, weather, and/or lighting). For example, an environmental context can include that it is raining outside, that it is daytime, and/or that a device is currently located in a park. In some embodiments, a device (e.g., using an agent) determines an environmental context (e.g., to be currently true, occurring, and/or applicable) by detecting input (e.g., via one or more input devices) and/or receiving data (e.g., from one or more other devices and/or components in communication with the device).

Reference is made herein to user context (also referred to herein as a “context of a user” and/or “a context corresponding to a user”). In some embodiments, a user context is a context based on one or more characteristics of a user. For example, a user context can include a subject’s appearance and/or clothing, personality, actions, behavior, movement, location, and/or pose. In some embodiments, a device (e.g., using an agent) determines a user context (e.g., to be currently true, occurring, and/or applicable) by detecting input (e.g., via one or more input devices) and/or receiving data (e.g., from one or more other devices and/or components in communication with the device). In some embodiments, a device determines user context based on historical context and/or learned characteristics of the subject, where one or more characteristics of the subject are learned and/or stored over a period of time by the device.

Reference is made herein to operational context (also referred to herein as a “context of operation” and/or an “operating context”). In some embodiments, an operational context is a context based on one or more characteristics of the operation of a device (e.g., the device determining and/or accessing the operational context and/or one or more other devices). For example, an operational context can include an internal state of the device (and/or of one or more components of the device), an internal dialogue of the device (e.g., the device’s understanding of a context), operations being performed by the device, applications and/processes that are executing (e.g., running and/or open) on the device. In some embodiments, a device (e.g., using an agent) determines an operational context (e.g., to be currently true, occurring, and/or applicable) by detecting input (e.g., via one or more input devices) and/or receiving data (e.g., from one or more other devices and/or components in communication with the device). In some embodiments, a device (e.g., using an agent) determines an operational context (e.g., to be currently true, occurring, and/or applicable) by assessing one or more internal states (e.g., accessed, retrieved, and/or queried by a process of the device).

Reference is made herein to “performing output,” “causing output,” “outputting,” and/or similar phrases. Such phrases can be interchangeable and/or include computer system itself performing such output or causing another computer system to perform such output. Reference is made herein to “displaying,” “causing display of,” “outputting visual content,” and/or similar phrases. Such phrases can be interchangeable and/or include computer system itself displaying or causing another computer system to perform such display. Reference is made herein to “outputting audio,” “causing output of audio,” “providing audio output,” and/or similar phrases. Such phrases can be interchangeable and/or include computer system itself outputting audio or causing another computer system to perform such output.

Attention is now directed towards embodiments of user interfaces (“UI”) and associated processes that are implemented on an electronic device, such as computer system 100, device 200, computer system 222, hub device 304, camera 306, smart speaker 308, smart light 310, smart lock 312, personal device A 314, or personal device B 316.

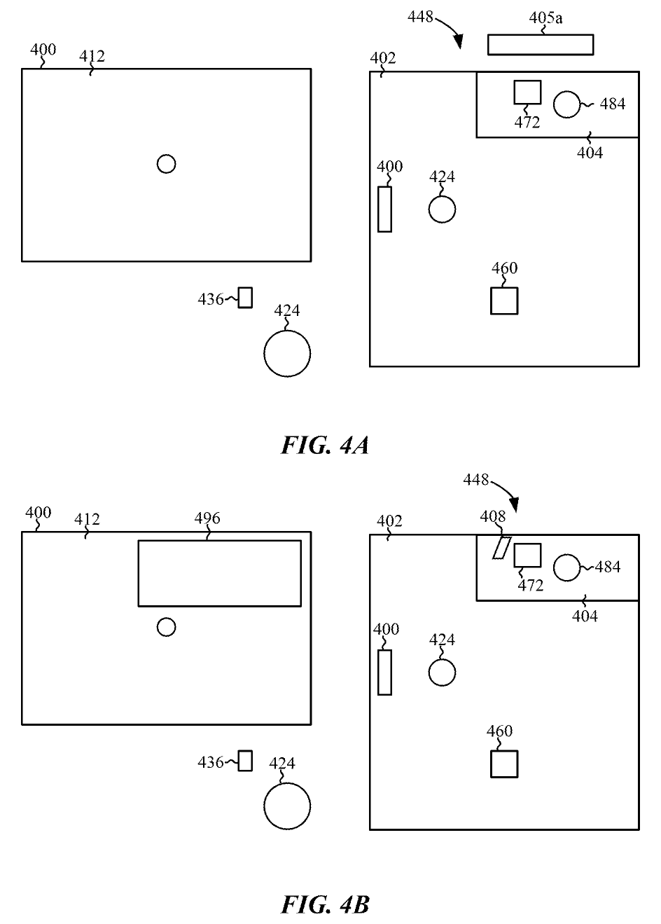

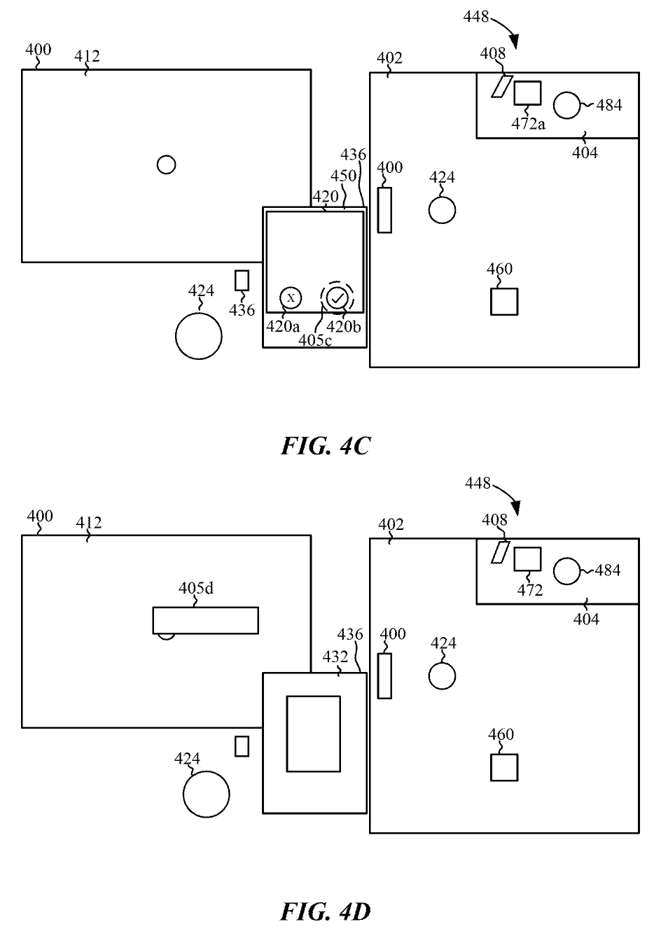

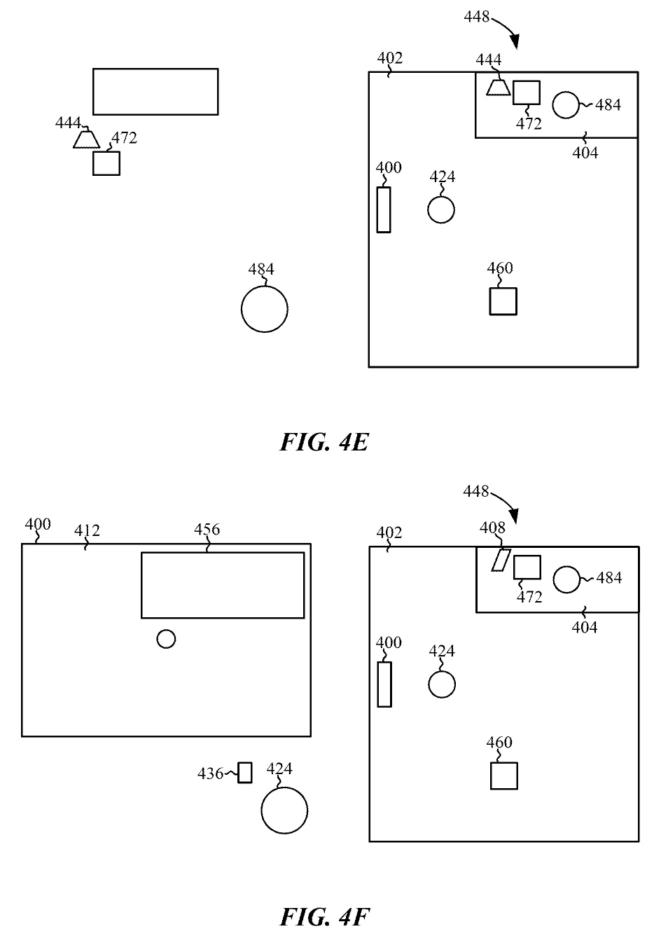

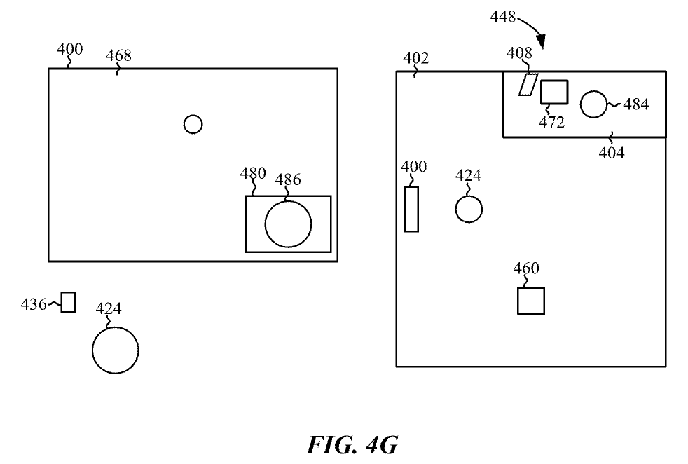

FIGS. 4A-4G illustrate exemplary user interfaces for outputting content in accordance with some embodiments. The user interfaces in these figures are used to illustrate the processes described below, including the processes in FIGS. 5-8.

The left side of FIGS. 4A-4G illustrate computer system 400 as a television. It should be recognized that computer system 400 can be other types of computer systems such as a tablet, a communal device, a smart phone, a smart watch, a laptop, an accessory, a personal gaming system, a desktop computer, a fitness tracking device, and/or a head-mounted display (HMD) device. In some embodiments, computer system 400 includes and/or is in communication with one or more input devices (e.g., a sensor, a camera, a lidar detector, a motion sensor, an infrared sensor, a touch-sensitive surface, a physical input mechanism, and/or a microphone). In some embodiments, computer system 400 includes and/or is in communication with one or more output devices (e.g., a display screen, a projector, a touch-sensitive display, and/or a speaker. In some embodiments, computer system 400 includes one or more components and/or features described above in relation to computer system 100 and/or electronic device 200. The left side of FIGS. 4A-4G also illustrate John 424 (e.g., corresponding to a subject named John) and computer system 436 (e.g., a tablet belonging to John).

The right side of FIGS. 4A-4G illustrate environment 448. In some embodiments, environment 448 is a common location, such as a home, an office, and/or a school. As illustrated in FIG. 4A, environment 448 includes living room 402 and bedroom 404. Bedroom 404 includes computer system 472 and Sarah 484 (e.g., corresponding to a subject named Sarah). Living room 402 includes computer system 400, John 424, and hub device 460 (such as described above with respect to hub device 304).

At FIGS. 4A-4G, hub device 460 is in communication with computer system 436, computer system 472 (e.g., a smart speaker), and/or a camera (e.g., a camera within environment 448). It should be recognized that any mention to the camera within environment 448 will be referred to as “the camera” throughout this application. In some embodiments, environment 448 includes other computer systems not illustrated in FIGS. 4A-4G, such as a smart lock, a smart thermostat, other types of accessory devices, and/or other personal devices of different users.

FIGS. 4A-4B illustrate a scenario where hub device 460 shares media in a session from one computer system to another in response to receiving information from the camera. In some embodiments, a session is started when a computer system (e.g., computer system 400) begins outputting content and ends when the computer system ceases outputting the content. For example, if hub device 304 causes computer system 400 to output a movie, the period from when computer system 400 begins outputting the movie to the time computer system 400 ceases outputting the movie is a session. In some embodiments, hub device 460 is able to keep track of any ongoing sessions within the environment through communication with other computer systems within environment 448 and/or through communication with the camera. In some embodiments, hub device 460 is able to keep track of any ongoing sessions within the environment through communication with other computer systems within environment 448 and/or through communication with the camera and causes an ongoing session to be shared from one computer system to another in response to information received from the camera.

As illustrated in FIG. 4A, computer system 400 displays baseball content 412 (e.g., a baseball game) and outputs audio of the baseball game. In some embodiments, hub device 460 causes the output of baseball content 412 on computer system 400 in response to receiving information from the camera. For example, in response to receiving captured images and/or video of John in front of computer system 400 from the camera, hub device 460 can communicate with computer system 400 to output baseball content 412 on computer system 400. In other embodiments, hub device 460 causes output of baseball content 412 on computer system 400 without receiving information from the camera. For example, in response to detecting a verbal input directed to hub device 460, “Play the baseball game on my TV,” hub device 460 can communicate with computer system 400 to output baseball content 412 on computer system 400. In some embodiments, computer system 400 outputs baseball content 412 without receiving communication from hub device 460. For example, John can use a remote control to turn on computer system 400 and select baseball content 412 from a channel guide. For another example, John can use computer system 400 to select baseball content 412 from a streaming application.

At FIG. 4A, computer system 472 detects input 405a, as a request from Sarah for the game to be played at the same location as Sarah (e.g., “Output the game here.”). Input 405adoes not specify what “game” is to be played or at what location the content is to be played. It should be recognized that input 405ais an example of a selection input as a verbal input detected via a microphone connected to and/or in communication with computer system 472 but can be other inputs, such as a tap input, an air gesture, and/or a button press. For example, computer system 472 can detect input 405aas an air-gesture request to play audio currently playing on computer system 400. In some embodiments, computer system 472 receives a request to output the game via a signal and/or notification from a personal computer system (e.g., a smartphone, tablet, and/or smartwatch) associated with Sarah as a result of Sarah directing an input to the personal computer system to request the output.

At FIG. 4B, in response to detecting input 405a, computer system 472 communicates with hub device 460, which, in response, sends audio content of the baseball game to computer system 472. At FIG. 4B, in response to receiving the audio content of the baseball game (e.g., audio portion of baseball content 412) from hub device 460, computer system 472 outputs baseball audio 408. In some embodiments, hub device 460 responds to the communication with computer system 472 with audio content of the baseball game based on a determination that “the game” requested in input 405a is the baseball game within baseball content 412. For example, the determination that “the game” requested in input 405a is the baseball game including baseball content 412 can be based on baseball content 412 being a session in environment 448. For another example, the determination that “the game” requested in 405a is the baseball game including baseball content 412 can be based on Sarah previously being detected in living room 402 when computer system 400 began outputting baseball content 412 (e.g., hub device 460 uses the context of Sarah being detected in living room 402 at the start of the session to determine that baseball content 412 is the content referred to in input 405a). For yet another example, the determination that “the game” requested in 405a is the baseball game including baseball content 412 can be based on computer system 400 detecting Sarah request the output of baseball content 412 on computer system 400 before computer system 472 detects input 450a. For yet another example, the determination that “the game” requested in 405a is the baseball game including baseball content 412 can be based on hub device 460 and/or another computer system in communication with hub device 460 having information that Sarah follows media pertaining to a team playing in baseball content 412. In some embodiments, hub device 460 selects baseball content 412 from among a plurality of ongoing sessions. For example, a determination can be made based on Sarah being detected at a location where baseball content 412 was output and not at a location where a different game content was output.

In some embodiments, hub device 460 responds to the communication with computer system 472 by sending audio content of the baseball game to computer system 472 based on a determination that the “here” within input 405a is corresponds to computer system 472. For example, a determination can be made that the “here” corresponds to computer system 472 due to input 405a being detected by computer system 472. For another example, a determination can be made that “here” corresponds to computer system 472 due to Sarah being detected, via a microphone of computer system 462, in bedroom 404, and computer system 472 being the only device within bedroom 404 capable of outputting media.

At FIG. 4B computer system 472 only outputs baseball audio 408, which is the audio portion of baseball content 412, due to being a smart speaker, whereas computer system 400 outputs both audio and visual content corresponding to baseball content 412. In some embodiments, computer system 472 is a type of computer system capable of displaying both audio and visual content (e.g., such as a television, a tablet, a smart phone, and/or a laptop computer) and outputs both the audio and visual portions of baseball content 412 in response to detecting input 405a. For example, if computer system 472 is a tablet, in response to receiving communication from hub device 460 to output baseball content 412, computer system can output the audio and visual content of baseball content 412. In some embodiments, computer system 472 outputs only visual content of baseball content 412 (e.g., if computer system 472 is a monitor without audio capabilities).

In some embodiments, the camera (e.g., not computer system 472) captures Sarah’s request for the game to be played in bedroom 404 and communicates the request to hub device 460, which sends audio of the baseball game to computer system 472. For example, the camera can capture images and/or videos of Sarah requesting that the game is played in bedroom 404. For another example, the camera can capture images and/or video of Sarah moving from living room 402 into bedroom 404 after computer system 400 began outputting baseball content 412 and, in response without detecting an explicit request, communicate with hub device 460 to initiate output of audio of the baseball game on computer system 472. In other embodiments, a microphone included in the camera captures input 405a as Sarah requesting audio of the game be played in the bedroom (e.g., “Play the game in the bedroom.”) and, in response, the camera communicates with hub device 460, which sends audio of the baseball game to computer system 472. In some embodiments, hub device 460 detects John request computer system 400 output baseball content 412 and detects Sarah request for the game to be played on computer system 472.

In some embodiments, the output of computer system 472 is synchronized to the output of computer system 400 (e.g., the same rate of output, the same volume, and/or same time of output). In other embodiments, the output of computer system 472 is not synchronized to the output of computer system 400. For example, the output of computer system 472 is delayed compared to the output of computer system 400. For another example, the output of computer system 472 is output at a different volume than the output of computer system 400. For another example, the output of computer system 472 is output at a different speed than the output of computer system 400. For another example, the output of computer system 472 is different but related content to baseball content 412, such as computer system 472 outputting radio commentary corresponding to baseball content 412, or such as player statistics or a different camera angle.

In some embodiments, the output of computer system 472 is synchronized to the output of computer system 400 and becomes unsynchronized in response to detecting an input. For example, in response to detecting, “Increase the volume of the game,” computer system 472 increases the volume of output and becomes unsynchronized from the output of computer system 400 due to the change in volume. For another example, in response to detecting, “Rewind fifteen seconds,” computer system 472 rewinds fifteen seconds in the output and becomes unsynchronized from the output of computer system 400 due to the change in playback. In some embodiments, the output of computer system 472 becomes re-synchronized with computer system 400 in response to detecting a subsequent input (e.g., “Sync with the living room”).

As illustrated in FIG. 4B, while displaying baseball content 412, in response to receiving communication from hub device 460 that computer system 472 is outputting the audio content of baseball content 412, computer system 400 displays notification 496, “Sarah has joined the session from the bedroom”. In some embodiments, computer system 400 displays notification 496 with an indication of the content. For example, “Sarah is listening to the baseball game from the bedroom”. In some embodiments, hub device 460 communicates with computer system 400 to display a notification indicating that Sarah has joined the session based on a determination that John and/or another subject is in front of computer system 400 (e.g., through communication with computer system 400 that John is interacting with computer system 400 and/or through communication with the camera). In other embodiments, hub device 460 communicates with computer system 400 to display a notification indicating that Sarah has joined the session based on a determination that John and/or another subject is near computer system 400 (e.g., within the same room).

In some embodiments, in response to receiving communication from hub device 460 that computer system 472 is outputting the audio content of baseball content 412, computer system 400 outputs an audible output with the same information as notification 496, “Sarah has joined the session from the bedroom”. In other embodiments, in response to receiving communication from hub device 460 that computer system 472 is outputting the audio content of baseball content 412, computer system 400 both displays notification 496 and outputs an audible output with the same information as notification 496.

In some embodiments, the camera detects that computer system 472 is outputting the audio content of baseball content 412 and, in response, communicates with hub device 460 that computer system 472 is outputting the audio content of baseball content 412. For example, the camera can detect that computer system 472 is outputting the audio content of baseball content 412 by detecting the audio content through a microphone included in the camera, and/or in response to capturing images and/or video of Sarah listening, engaging with, and/or affirming that computer system 472 is outputting the audio content of baseball content 412.

In some embodiments, computer system 400 ceases display of notification 496 after a predetermined amount of time. For example, computer system 400 ceases display of notification 496 after ten seconds have elapsed. In other embodiments, computer system 400 maintains display of notification 496 until notification 496 is dismissed. For example, in response to detecting a verbal input (e.g., “Got it, thank you.”), computer system 400 ceases display of notification 496.

In some embodiments, in response to receiving communication from the camera that Sarah stopped listening to baseball content 412, hub device 460 communicates with computer system 400 to display a notification that Sarah stopped listening to baseball content 412 (e.g., “Sarah exited the ongoing session”). For example, in response to receiving information that Sarah stopped listening to baseball content 412 from hub device 460, computer system 400 displays a notification of “Sarah has exited the session”. In other embodiments, in response to receiving communication from hub device 460 that Sarah stopped listening to baseball content 412, computer system 400 does not display a notification that Sarah stopped listening to baseball content 412.

In some embodiments, in response to receiving information of John requesting baseball content be output on computer system 472 after receiving information that John requested baseball content 412 be output on computer system 400, hub device 460 communicates with computer system 472 to output baseball audio 408. For example, after causing computer system 400 to output baseball content 412, the camera detects John go into bedroom 404 and directs an input requesting baseball content be output on computer system 472. In response, the camera communicates the information to hub device 460, which then communicates with computer system 472 to output baseball audio 408. In some embodiments, in response to receiving information of John moving from living room 402 to bedroom 404, hub device 460 causes computer system 400 to cease outputting baseball content 412 after causing output of baseball audio 408 on computer system 472, such that the session effectively moves with John.

FIGS. 4C-4D illustrate a scenario where computer system 436 displays supplemental information corresponding to baseball content 412 in response to receiving communication from hub device 460. At FIG. 4C, hub device 460 receives communication (e.g., including images and/or video) from the camera that John is directing attention to computer system 436. For example, hub device 460 can receive captured images and/or video of John looking at computer system 436 for a predefined amount of time (e.g., 60 seconds), of John directing a gaze input to computer system 436, and/or of John holding computer system 436 at eye level. In some embodiments, a determination is made that John is directing attention to computer system 436 based on detecting an input via a microphone connected to and/or in communication with hub device 460. For example, a determination is made that John is directing attention to computer system 436 based on receiving communication from a microphone that detected an input of, “I’m holding my tablet,” and/or “I wonder what this batter’s batting average is.” In other embodiments, a determination is made that John is directing attention to computer system 436 based on receiving communication from computer system 436.

At FIG. 4C, in response to receiving communication that John is directing attention to computer system 436 while computer system 400 is displaying baseball content 412, hub device 460 communicates with computer system 436 to display an indication with a prompt to display supplemental information for baseball content 412. As illustrated in FIG. 4C, in response to receiving communication from hub device 460, computer system 436 displays user interface 450. User interface 450 includes prompt 420, “Would you like to see more information related to the game?”. Additionally, prompt 420 includes deny button 420aand allow button 420b.

In some embodiments, in response to receiving information from the camera that John is no longer directing his attention to computer system 436, hub device 460 causes computer system 436 to cease displaying user interface 450 (e.g., including prompt 420, deny button 420a, and allow button 420b). In other embodiments, computer system 436 continues displaying user interface 450 (e.g., including prompt 420, deny button 420a, and allow button 420b) in response to receiving communication from hub device 460 that John is no longer directing his attention to computer system 436. For example, hub device 460 receives information from the camera that John has lowered computer system 436, averted his gaze, looked away, or left the room. In some embodiments, computer system 436 ceases display of user interface 450 after a predetermined timeout if no input is detected on prompt 420.

At FIG. 4C, computer system 436 detects input 405c on allow button 420b. It should be recognized that input 405c is an example of a selection input as a tap input but can be other inputs, such as a verbal input detected via a microphone (e.g., “Yes please” or “Show me stats”), an air gesture (e.g., a swipe toward computer system 436), a gaze selection on allow button 420b, and/or a button press on computer system 436.

As illustrated in FIG. 4D, in response to detecting input 405c, computer system 436 ceases display of user interface 450 and displays information user interface 432. Information user interface 432 includes supplemental information corresponding to baseball content 412, including a current batter’s name, profile picture, batting average, and total home runs for the season. In some embodiments, the supplemental information is sourced the internet. In other embodiments, the supplemental information is sourced from baseball content 412. In some embodiments, computer system 436 displays the supplemental information automatically in response to receiving communication that John is directing attention to computer system 436 from hub device 460. In some embodiments, in response to detecting an input directed to deny button 420a, computer system 436 ceases display of prompt 420 and does not display supplemental information related to baseball content 412.

As illustrated in FIG. 4D, the supplemental information is different than baseball content 412. For example, computer system 400 displays baseball content 412 as a real-time view of the baseball game, whereas computer system 436 displays information that supplements baseball content 412 with information not found in baseball content 412, such as the current batter’s name, profile picture, and statistics. For another example, computer system 436 displays the supplemental information as purely visual, whereas computer system 400 displays baseball content 412 with visual and audio components. For another example, computer system 436 can display supplemental information including real-time fantasy points or player comparison charts not present in the broadcast view of baseball content 412. In some embodiments, the supplemental information includes data overlaid or derived from baseball content 412 but presented in a different format (e.g., graphical statistics instead of on-screen ticker).

In some embodiments, computer system 436 displays supplemental information that is found in baseball content 412. For example, computer system 436 displays supplemental information that includes the current score, which computer system 400 also displays as part of baseball content 412. In other embodiments, computer system 436 displays exclusive supplemental information that is not found in baseball content 412. For example, computer system 436 displays special trivia about the current batter that corresponds to baseball content 412.

In some embodiments, hub device 460 does not communicate with computer system 436 to display supplemental information if John does not direct his attention to computer system 436. In some embodiments, hub device 460 does not communicate with computer system 436 to display supplemental information if computer system 400 is not outputting content. For example, hub device 460 does not communicate with computer system 436 to display supplemental information if computer system 400 is off. In some embodiments, hub device 460 does not communicate with computer system 436 to display supplemental information if computer system 400 is displaying certain information, such as a video call, private information, and/or health documents.

In some embodiments, hub device 460 communicates with a different computer system to display supplemental information. For example, if John is holding both computer system 436 and his personal smartphone and is directing his attention towards the smartphone, in response to receiving communication from the camera that John is directing his attention towards the smartphone, hub device 460 can cause the smartphone to display the supplemental information. In some embodiments, the different computer system displays the same supplemental information as computer system 436 (e.g., information user interface 432). In other embodiments, the different computer system displays different supplemental information than computer system 436. For example, computer system 436 can display the supplemental information illustrated in FIG. 4D and the different computer system can display supplemental information about the at-bat team’s history. For another example, in the scenario where hub device 460 causes a speaker in living room 402 to output supplemental information, the speaker outputs an audio summary of the game to the present point instead of visual content.

In some embodiments, hub device 460 communicates with the same type of computer system as computer system 436 to display supplemental information. For example, if John is holding both computer system 436 and another tablet and is directing his attention towards the other tablet, in response to receiving communication from the camera that John is directing his attention towards the other tablet, hub device 460 causes the other tablet to display the supplemental information. In some embodiments, when multiple similar devices are available, hub device 460 selects the one receiving the strongest attention indicators from the camera (e.g., closest proximity or longest gaze duration).

In some embodiments, in response to detecting John switched his attention from computer system 436 to the different computer system while displaying the supplemental information, hub device 460 communicates with the different computer system to display the supplemental information. For example, in response to receiving information from the camera that John stopped directing attention at computer system 436 and is directing attention to the other tablet, hub device 460 causes computer system 436 to cease displaying the supplemental information and causes the other tablet to display the supplemental information.

In some embodiments, hub device 460 causes computer system 436 to cease displaying information user interface 432 (e.g., including the supplemental information) in response to receiving communication from the camera that John is no longer directing his attention to computer system 436. In some embodiments, hub device 460 causes computer system 436 to continue displaying information user interface 432 (e.g., including the supplemental information) in response to receiving communication from the camera that John is no longer directing his attention to computer system 436. In such embodiments, computer system 436 continues displaying information user interface 432 until an input is detected to dismiss the supplemental information and/or until a predefined amount of time expires (e.g., 30 seconds).

At FIG. 4D, hub device 460 detects input 405d as a message from John to Sarah (e.g., “Tell Sarah this is a great game.”). It should be recognized that input 405d is an example of a non-selection input as a verbal input that is detected via a microphone connected to and/or in communication with hub device 460 but can be other forms of inputs, such as gestured message or typed input on computer system 436. It should be recognized that input 405dis directed from John to Sarah with a request for whatever computer system is closest to Sarah to output a message of, “This is a great game.” Additionally, input 405ddoes not include a location for Sarah, nor a target computer system for the message. For example, input 405dcan include phrases such as “Let Sarah know the game is exciting” or “Message Sarah: great play!”. In some embodiments, input 405dis detected as directed to Sarah based on name mention and/or contextual analysis (e.g., ongoing session involving Sarah). In some embodiments, the indication of the content is a title of the content. For example, input 405dincludes a phrase such as “Tell Sarah the title of this show” or “Message Sarah: check out this movie name.” In some embodiments, the indication of the content includes a summary of the content. For example, input 405dincludes a phrase such as “Let Sarah know this game is intense with great plays” or “Tell Sarah the plot is exciting.” In some embodiments, the indication of the content includes a description of the content. For example, input 405dcan include a phrase such as “Message Sarah that the players are making amazing shots” or “Tell Sarah about the thrilling comeback in this match.” In some embodiments, the indication of the content does not explicitly reference the content. For example, input 405dcan include a phrase such as “Tell Sarah this is awesome” or “Message Sarah: wow, unbelievable!”

In some embodiments, input 405d corresponds to a request to output content to Sarah (e.g., a message or media). For example, input 405dincludes a phrase such as “Tell Sarah this is a great game,” “Display the score to Sarah,” or “Play this song for Sarah.” In some embodiments, the input includes a request for a particular computer system to output the content. For example, input 405dcan include a phrase such as “Tell Sarah on the bedroom TV that this is exciting.” In some embodiments, the request does not include an indication of a computer system. For example, input 405dcan include a phrase such as “Let Sarah know we’re watching a thriller” without specifying a device for output. In some embodiments, the input includes a request to output the content with one or more characteristics, such as volume, speed, a location within the content, and/or length of time. For example, input 405dcan include a phrase such as “Tell Sarah loudly that the team scored” or “Message Sarah to fast-forward to the good part.” In some embodiments, the input that corresponds to the subject includes a request to output a particular portion of the content. For example, input 405dcan include a phrase such as “Show Sarah the replay of that goal.” In some embodiments, the input includes a request to output the content at a particular time. For example, input 405dcan include a phrase such as “Tell Sarah about this play when she gets home.”

In some embodiments, hub device 460 detects input 405d via the camera. For example, the camera captures images and/or videos of John requesting to send Sarah a message. For another example, a microphone included in the camera captures input 405d.

At FIG. 4E, in response to detecting input 405d, hub device 460 sends the message from input 405d (e.g., “This is a great game.”) to computer system 472. In some embodiments, a determination is made to send the message to computer system 472 based on detecting that Sarah most recently interacted with computer system 472 (e.g., based on receiving communication of the recent input of input 405a). In some embodiments, a determination is made as to which computer system to send the message based on detecting the computer system with which the user (e.g., Sarah) most recently interacted. For example, the message is sent to computer system 472 in response to detecting that Sarah most recently interacted with computer system 472 (e.g., based on receiving communication of the recent input of input 405a). In some embodiments, if Sarah most recently interacted with a different computer system (e.g., a television in the bedroom or a communal device in another room), the message is routed to that different computer system instead. In some embodiments, the message is sent to a personal device (e.g., a smartphone or tablet) associated with Sarah that is determined to be located in the room where Sarah most recently interacted with a computer system.

FIG. 4E illustrates the perspective of bedroom 404 on the left side instead of the perspective of living room 402. The left side of FIG. 4E also illustrates Sarah 484 and computer system 472. At FIG. 4E, in response to receiving the message corresponding to input 405d from hub device 460, computer system 472 ceases output of the audio content of the baseball audio 408 and outputs audio message 444, (e.g., John’s message, “This is a great game”). In some embodiments, audio message 444 includes a recording of John’s voice captured from input 405d. In other embodiments, audio message 444 includes a synthesized audio of content included in recording of John’s voice captured from input 405d. In between FIGS. 4E-4F, computer system 472 ceases outputting John’s message and resumes outputting the audio content of baseball content 412, as illustrated by baseball audio 408.

In some embodiments, in the scenario where hub device 460 sends the message to a computer system different than computer system 472, the message can be output and/or displayed differently. For example, if hub device 460 sends the message to a television computer system, the television computer system can both output the message audibly and display a visual representation of the message. For another example, if hub device 460 sends the message to a smartphone, the smartphone can output the message via a digital assistant with an input such as, “Hey Sarah, John wants you to know that this is a good game.”

In some embodiments, the computer system that outputs the content varies based on the type of device with which the user most recently interacted and the nature of the content. For example, computer system 472 (e.g., a smart speaker) can be a different type of computer system than a television in the bedroom, where the message is sent to the television in response to detecting that Sarah most recently interacted with the television. In some embodiments, the content is not output by computer system 472 when the content is output via the television in the bedroom. For example, the content is output only via the television in the bedroom and is not output by computer system 472 when the content is output at the television. In some embodiments, the content is output by computer system 472 when the content is output via the television in the bedroom. For example, the content is output concurrently via both the television in the bedroom and computer system 472. In some embodiments, the television in the bedroom outputs a first portion of the content (e.g., video content) and computer system 472 outputs a second portion of the content (e.g., audio content). For example, audio content is output via computer system 472 and video content is output via the television in the bedroom.

In some embodiments, hub device 460 sends the message to a default computer system in response to a determination that the computer system that Sarah most recently interacted with is both incapable of outputting content and/or in a location where other nearby computer systems are also incapable of outputting content. For example, in response to a determination that Sarah most recently interacted with a smart thermostat in the basement, and the nearby computer systems are also incapable of outputting content, hub device 460 sends the message to computer system 400. For another example, in response to a determination that Sarah most recently interacted with a smart lock in the garage and there are no other nearby computer systems capable of outputting content, hub device 460 sends the message to computer system 400. In some embodiments, the default computer system is selected by a subject and/or is selected based on historical preferences of the subject. In such embodiments, hub device 460 sends the message to a default computer system to facilitate that the message is output somewhere to avoid not outputting anything at all. For example, the default computer system can be a personal computer system of Sarah.

In some embodiments, hub device 460 sends the message to a device based on a detected location of the intended recipient rather than the most recently interacted with computer system. For example, in response to receiving communication of images of Sarah in the kitchen from the camera, hub device 460 sends the message to a computer system in the kitchen capable of outputting the message despite computer system 472 being the most recently interacted with computer system.

In some embodiments, before sending the message, a determination is made of Sarah’s location to ensure the message is received. For example, the camera can determine Sarah’s location through captured images and/or video and communicates the location to hub device 460. For another example, hub device 460 can determine Sarah’s location through receiving images of Sarah from the camera. For yet another example, hub device 460 can determine Sarah’s location through detecting signals and/or communications from Sarah’s personal computer system. For another example, hub device 460 determines Sarah’s location through receiving communication from other computer systems within environment 448.

In some embodiments, hub device 460 does not send the message corresponding to input 405d. For example, in response to a determination that Sarah has not recently interacted with any computer systems in environment 448 (e.g., Sarah has not interacted with any computer systems for the last ten minutes), hub device 460 does not send the message. For another example, in response to a determination that Sarah recently interacted with a computer system in a location where no computer system is capable of outputting the message, hub device 460 does not send the message. In such embodiments, hub device 460 communicates with computer system 400 and/or computer system 436 to display an indication that the message was not sent. For example, hub device 460 causes computer system 436 (e.g., the device from which the input was received) to display a notification such as “Message to Sarah could not be delivered” or “Unable to reach Sarah at this time.” In some embodiments, the indication includes a reason why the content was not output. For example, the displayed indication includes text such as “Sarah is not near any device” or “No recent activity detected for Sarah.”

In some embodiments, in response to a determination that Sarah has not responded to the message, hub device 460 sends the message to Sarah’s personal computer system. For example, in response to a determination that Sarah has not responded to the message output by computer system 472, hub device 460 is not sure of Sarah’s location and can send the message to Sarah’s personal computer system.

FIGS. 4F-4G illustrate a scenario where hub device 460 receives a notification that an external subject (e.g., a subject outside of and/or not registered with environment 448) wants to share content with environment 448. The left side FIG. 4F illustrates the perspective of living room 402, including computer system 400, computer system 436, and John 424. At FIG. 4F, hub device 460 receives a notification that an external computer system of a subject (e.g., referred to below as Mike), wants to share concert content with environment 448 and, in response, a determination is made on where to send the concert content in environment 448. In some embodiments, the determination is made by hub device 460.

At FIG. 4F, after receiving the notification, in response to detecting that John is in front of computer system 400, via communication with the camera, a determination is made to send the concert content to computer system 400. In response to the determination to send the concert content to computer system 400, hub device 460 communicates with computer system 400. As illustrated in FIG. 4F, in response to receiving communication from hub device 460, computer system 400 displays notification 456, “Mike wants to share with your home.”

In some embodiments, a determination is made to send the concert content to computer system 400 based on a determination that computer system 400 can display the concert content and output the concert audio (e.g., computer system 400 is best suited to output the concert content for the best viewing and listening experience). In some embodiments, a determination is made to send the concert content to a different computer system in environment 448, such as computer system 436, based on a determination that the other computer system is better suited to display the concert content and output the concert audio. In some such embodiments, hub device 460 sends different types of content to different computer systems. For example, in a scenario where Mike is sharing a song with environment 448, in response to a determination that the type of content Mike is trying to share is purely audio content, a determination can be made to send the audio content to computer system 472.

In some embodiments, a determination is made to send the concert content to a computer system based on the intended recipient. For example, in response to receiving communication from Mike that the concert content is intended for John, in response to receiving captured images and/or video of John in front of computer system 400, a determination is made to send the concert content to computer system 400. For another example, in response to receiving communication from Mike that the concert content is intended for Sarah, in response to receiving captured images and/or video of Sarah in bedroom 404, a determination is made to send the concert content to computer system 472. In some embodiments, a determination is made to send the concert content to a computer system based on subject interest to the content. For example, if Mike is sending content corresponding to a video of dogs, a determination is made that John likes dogs and Sarah does not and, in response to receiving images of John in front of computer system 400 from the camera, hub device 460 sends the concert content to computer system 400.

In some embodiments, a determination is made to send the concert content based on time of day. For example, in a scenario where hub device 460 receives communication from Mike at 9:00PM, a determination is made to send the concert content to a television computer system in bedroom 404 based on a determination that John and/or Sarah are likely in bedroom 404 getting ready for bed and/or in response to receiving captured images of John and/or Sarah in bedroom 404 getting ready for bed from the camera. For another example, in a scenario where hub device 460 receives communication from Mike at 12:00PM, a determination is made to send the concert content to a smart speaker in the kitchen based on a determination that John and/or Sarah are likely in the kitchen eating lunch and/or in response to receiving captured images of John and/or Sarah in the kitchen eating lunch from the camera.

In some embodiments, hub device 460 does not send the concert content to a certain computer system based on a determination that the certain computer system is incapable and/or inadequate for outputting the notification. For example, hub device 460 does not send the concert content to a smart thermostat or smart refrigerator based on a determination that neither the smart thermostat nor smart refrigerator can output the notification. For another example, hub device 460 does not send the concert content to a smartphone based on a determination that the size of the smart phone is inadequate for displaying the concert content (e.g., another computer system is better suited for displaying the visual content of the concert content and/or the smartphone is off). For another example, hub device 460 does not send the concert content to a tablet based on subject preference that content is not output on the tablet.

In some embodiments, hub device 460 does not send the concert content to computer system 436, computer system 472, and/or any other computer system in environment 448 because hub device 460 has already sent the concert content to computer system 400. In some embodiments, because computer system 400 is outputting the concert content, no other computer system within environment 448 outputs the concert content.

As illustrated in FIG. 4G, after displaying notification 456, in response to receiving the concert content from hub device 460, computer system 400 ceases display of notification 456 and baseball content 412 and displays concert content 468 (e.g., a music concert) and outputs audio content of the concert. Additionally, in response to receiving the concert content from hub device 460, computer system 400 displays live feed 480 as overlaid on concert content 468. Live feed 480 includes Mike 486 (e.g., a representation of Mike). In some embodiments, hub device 460 displays live feed 480 and Mike 486 via computer system 400 to facilitate a joint watching experience between John and Mike.

In some embodiments, computer system 400 displays concert content 468 and baseball content 412 concurrently. For example, computer system 400 can display concert content 468 as overlaid on baseball content 412. For another example, computer system 400 can display concert content 468 and baseball content 412 side by side.

In some embodiments, hub device 460 does not communicate with computer system 400 to display notification 456 but rather communicates with computer system 400 to display concert content 468. In such embodiments, hub device 460 can communicate to computer system 400 to immediately display concert content 468 due to settings (e.g., John has set with hub device 460 that Mike can share content with the environment freely). In other embodiments, hub device 460 communicates with computer system 400 to display concert content 468 in response to detecting an input directed to notification 456. For example, in response to detecting an input of, “Ok, share Mike’s content,” hub device 460 communicates with computer system 400 to display concert content 468.

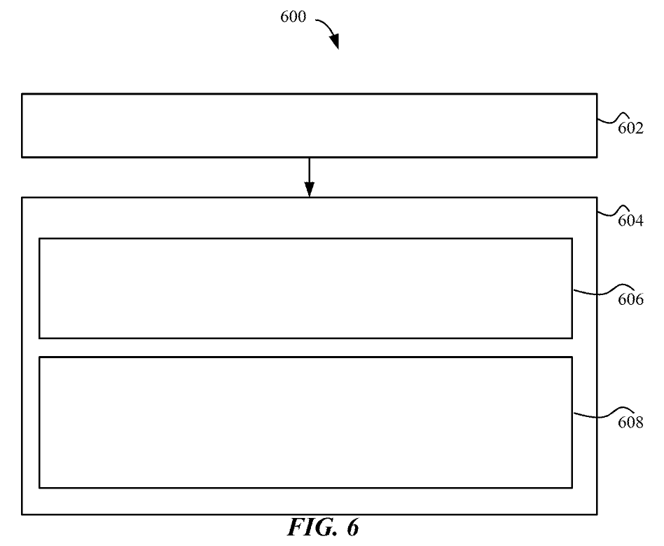

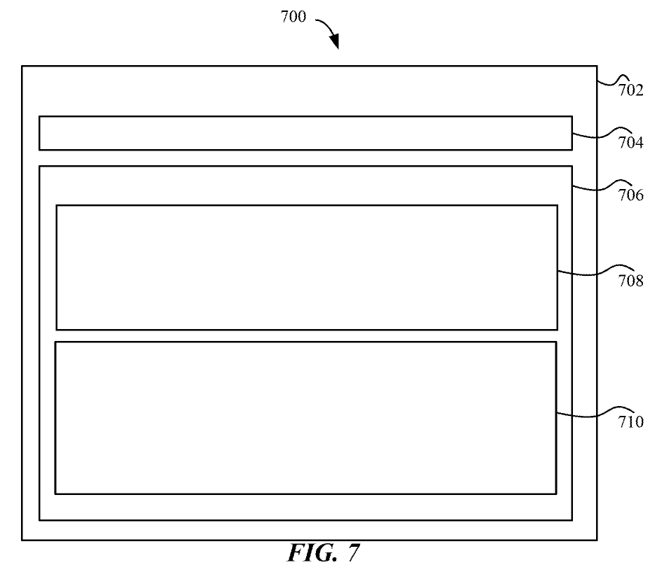

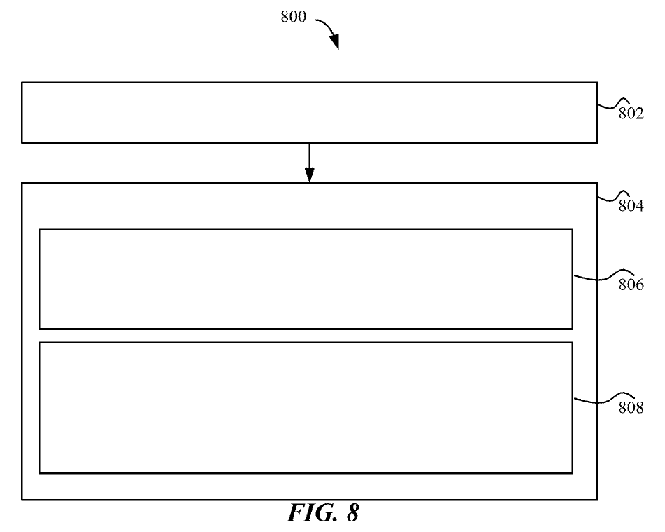

FIG. 5 is a flow diagram illustrating a process for outputting an indication that the content is in another area in accordance with some embodiments. The user interfaces in FIGS. 4A-4G are used to illustrate the processes described below, including the processes in FIG. 5. FIG. 6 is a flow diagram illustrating a process for causing output of content at different locations in accordance with some embodiments. The user interfaces in FIGS. 4A-4G are used to illustrate the processes described below, including the processes in FIG. 6. FIG. 7 is a flow diagram illustrating a process for causing output of complimentary content in accordance with some embodiments. The user interfaces in FIGS. 4A-4G are used to illustrate the processes described below, including the processes in FIG. 7. FIG. 8 is a flow diagram illustrating a process for outputting content related to other content in accordance with some embodiments. The user interfaces in FIGS. 4A-4G are used to illustrate the processes described below, including the processes in FIG. 8.

FIG. 5 is a flow diagram illustrating a process (e.g., process 500) for outputting an indication that the content in another area in accordance with some embodiments. Some operations in process 500 are, optionally, combined, the orders of some operations are, optionally, changed, and some operations are, optionally, omitted.

As described below, process 500 provides an intuitive way for outputting an indication that the content is in another area in accordance with some embodiments. Process 500 reduces the cognitive burden on a user, thereby creating a more efficient human-machine interface. For battery-operated computing devices, enabling a user to interact with such devices faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently.

In some embodiments, process 500 is performed at a first computer system (e.g., 400 and/or 460) (e.g., a watch, a phone, a tablet, a fitness tracking device, a processor, a head-mounted display (HMD) device, a communal device, a media device, a speaker, a television, an electronic device, and/or a personal computing device) that is in communication (e.g. wireless and/or wired communication) with (and/or includes) one or more output devices (e.g., a display generation component, an audio component, and/or a haptic component).

While outputting (e.g., audibly and/or visually outputting), via the one or more output devices, content (e.g., 412), the first computer system receives (502) (e.g., from another computer system external to the first computer system and/or a subject) an indication that a subject (e.g., 484) (e.g., a subject that is registered with the first computer system and/or a subject that is not registered with the first computer system) caused (or is causing or will cause) output of the content on a second computer system (e.g., 472) (e.g., a watch, a phone, a tablet, a fitness tracking device, a processor, a head-mounted display (HMD) device, a communal device, a media device, a speaker, a television, an electronic device, and/or a personal computing device) different (and/or separate) from the first computer system. In some embodiments, the first computer system is in communication with the second computer system. In some embodiments, the first computer system is a different type of computer system than the second computer system. In some embodiments, the first computer system is not in communication with the second computer system. In some embodiments, the content is a TV show, podcast, audio book, song, and/or movie. In some embodiments, the subject is a user, a person, an animal, another computer system different from the computer system, or a device. In some embodiments, the first computer system receives, from the second computer system, the indication that the subject caused output of the content on the second computer system.

In response to (504) receiving the indication that the subject caused output of the content on the second computer system, in accordance with a determination that the indication corresponds to a first area (e.g., 404) (e.g., a bedroom, kitchen, basement, and/or garage) of an environment (e.g., a home, building, school, and/or virtual environment), the first computer system outputs (506) (e.g., visually and/or audibly outputs), via the one or more output devices, an indication (e.g., 496) (e.g., a window, a widget, and/or a control) of the first area of the environment. In some embodiments, the indication corresponds to the first area when the content is output by the second computer system in the first area. In some embodiments, the indication corresponds to the first area when the second computer system is in the first area. In some embodiments, the first computer system outputs the indication of the first area of the environment for a predetermined period of time (e.g., 5-90 seconds). In some embodiments, the first computer system suspends output of the content while the first computer system outputs the indication of the first area of the environment. In some embodiments, the first computer system does not modify output of the content as part of outputting the indication of the first area of the environment.

In response to (504) receiving the indication that the subject caused output of the content on the second computer system, in accordance with a determination that the indication corresponds to a second area (e.g., garage, such as described above with respect to FIG. 4B) (e.g., a bedroom, kitchen, basement, and/or garage) of the environment, the first computer system outputs (508) (e.g., visually and/or audibly outputs), via the one or more output devices, an indication (e.g., a window, a widget, and/or a control) of the second area of the environment (e.g., without outputting the indication of the first area of the environment), wherein the second area is different from the first area. In some embodiments, the indication of the second area of the environment is different from the indication of the first area of the environment. In some embodiments, the first computer system outputs the indication of the second area of the environment for a predetermined period of time (e.g., 5-90 seconds). In some embodiments, the first computer system suspends output of the content while the first computer system outputs the indication of the second area of the environment. In some embodiments, the first computer system does not modify output of the content as part of outputting the indication of the second area of the environment. Providing improved feedback (such as by outputting an indication of an area a user caused output of content to a different computer system, and/or selectively displaying an indication of the user that caused output of the content to the different computer system) enhances the operability of the device by reducing accidental and mistaken inputs, reducing energy usage by the device. Performing an operation when a set of conditions has been met without requiring further user input (such as by outputting an indication of an area a user caused output of content to a different computer system, and/or selectively displaying an indication of the user that caused output of the content to the different computer system) enhances the operability of the device by reducing unnecessary inputs and/or steps to navigate through different user interfaces or sets of controls, reducing energy usage by the device.

In some embodiments, the indication of the first area of the environment is output in a first modality (e.g., visual, such as described above with respect to FIG. 4B) (e.g., an audible, visual and/or tactile modality) and a second modality (e.g., audio “Sarah is listening to the baseball game from the bedroom,” such as described above with respect to FIG. 4B) (e.g., an audible, visual and/or tactile modality). In some embodiments, the first modality is different from the second modality. In some embodiments, the indication of the first area is output in a single modality. In some embodiments, the indication of the second area of the environment is output in the first modality and the second modality. In some embodiments, the computer system outputs the indication of the second area of the environment in a third modality and a fourth modality. In some embodiments, the third modality is different from the first modality, the second modality, and/or the fourth modality. In some embodiments, the computer system outputs the indication of the first area of the environment and the indication of the second area of the environment in different modalities.

In some embodiments, the one or more output devices include (or consist of) one or more display generation components (e.g., a display screen, a projector, a head mounted display, and/or a touch-sensitive display). In some embodiments, outputting the indication of the first area of the environment includes displaying, via the one or more display generation components, the indication of the first area of the environment. In some embodiments, while displaying the indication of the first area of the environment, the first computer system maintains output of, via the one or more output devices, the content (e.g., 412 is maintained, such as described above with respect to FIG. 4B). In some embodiments, the computer system displays, via the one or more display generation components, the content while displaying, via the one or more display generation components, the indication of the first area of the environment.

In some embodiments, in response to receiving the indication that the subject caused output of the content on the second computer system (and/or while outputting the content, in accordance with the determination that the indication corresponds to the first area of the environment, and/or in accordance with the determination that the indication corresponds to the second area of the environment) (and/or in conjunction with, such as before, after, as a part of, or while, the first computer system outputs the indication of the first area of the environment or the indication of the second area of the environment), outputting, via the one or more output devices, an indication (e.g., “Sarah,” such as described above with respect to FIG. 4B) (e.g., an identification, a textual indication, and/or a graphical indication) of an identity of the subject. In some embodiments, the indication of the identity of the subject includes an image of the subject. In some embodiments, the indication of the identity of the subject includes a name of the subject.

In some embodiments, in response to receiving the indication that the subject caused output of the content on the second computer system (and/or while outputting the content, in accordance with the determination that the indication corresponds to the first area of the environment, and/or in accordance with the determination that the indication corresponds to the second area of the environment) (and/or in conjunction with, such as before, after, as a part of, or while, the first computer system outputs the indication of the first area of the environment or the indication of the second area of the environment), outputting, via the one or more output devices, an indication (e.g., “the baseball game,” such as described above with respect to FIG. 4B) (e.g., an identification, a graphical indication, and/or a textual indication) of the content. In some embodiments, the indication of the content includes a name of the content. In some embodiments, the indication of the content includes a summary of the content.

In some embodiments, output of the content by the first computer system and output of the content by the second computer system are not synchronized (e.g., the same rate of output, the same volume, and/or same time of output, such as described above with respect to FIG. 4B) (e.g., volume of output of the content by the first computer system is greater or less than volume of output of the content by the second computer system, output of the content by the first computer system is further along than output of the content by the second computer system, and/or the first computer system and the second computer system output the content at different rates). In some embodiments, output of the content by the first computer system and output of the content by the second computer system become synchronized after not being unsynchronized.

In some embodiments, output of the content by the first computer system and output by the content by the second computer system are synchronized (e.g., delayed, different volume, different speed, and/or different angle, such as described above with respect to FIG. 4B) (e.g., volume of output by the first computer system is the same as volume of the output by the second computer system, progression of output of the content by the first computer system is the same as progression of output of the content by the second computer system, and/or the first computer system and the second computer system output the content at the same rates). In some embodiments, output of the content by the first computer system and output of the content by the second computer system become unsynchronized after being synchronized.

In some embodiments, output of the content by the first computer system and output of the content by the second computer system is synchronized (e.g., volume of output of the content by the first computer system is the same as volume of output of the content by the second computer system, progression of output of the content by the first computer system is the same as progression of output of the content by the second computer system, and/or the first computer system and the second computer system output the content at the same rates) when the first computer system receives the indication that the subject caused output of the content on the second computer system. In some embodiments, output of the content by the first computer system and output of the content by the second computer system is not synchronized after the first computer system receives the indication (e.g., “rewind fifteen seconds,” such as described above with respect to FIG. 4B) that the subject caused output of the content on the second computer system (e.g., at some point after the first computer system receives the indication that the subject caused output of the content on the second computer system, the first computer system or the second computer system changed output of the content such that the content is no longer synchronized between the first computer system and the second computer system). In some embodiments, after receiving the indication that the subject caused output of the content on the second computer system, the first computer system detects, via one or more input devices included in and/or in communication with the first computer system, an input (e.g., a tap input, a voice command and/or eye gaze) corresponding to (e.g., directed to, at a location of, related to, and/or associated with) a request to desynchronize output of the content by the first computer system and output of the content by the second computer system. In some embodiments, in response to detecting the input corresponding to the request to desynchronize output of the content on the first computer system and output of the content on the second computer system, the first computer system desynchronizes output of the content by the first computer system and the output of the content by the second computer system. In some embodiments, after receiving the indication that the subject caused output of the content on the second computer system, the first computer system detects, via one or more input devices included in and/or in communication with the first computer system, an input (e.g., a tap input, a voice command and/or eye gaze) corresponding to (e.g., directed to, at a location of, related to, and/or associated with) a request (e.g., “increase the volume of the game,” such as described above with respect to FIG. 4B) to change output of the content via the first computer system. In some embodiments, in response to detecting the input corresponding to the request to change output of the content via the first computer system, the first computer system changes output of the content via the first computer system without changing output of the content via the second computer system. In some embodiments, after receiving the indication that the subject caused output of the content on the second computer system, the first computer system receives, from the second computer system, an indication that the second computer system has changed output of the content on the second computer system. In some embodiments, in response to receiving the indication that the second computer system has changed output of the content on the second computer system, the first computer system changes output of the content on the first computer system. In some embodiments, in response to receiving the indication that the second computer system has changed output of the content on the second computer system, the first computer system forgoes changing output of the content on the first computer system. In some embodiments, after receiving the indication that the subject caused output of the content on the second computer system, the first computer system receives, from the second computer system, a request to desynchronize output of the content by the first computer system and output of the content by the second computer system. In some embodiments, in response to receiving the request to desynchronize output of the content by the first computer system and output of the content by the second computer system, the first computer system desynchronizes output of the content by the first computer system and output of the content by the second computer system. In some embodiments, the first computer system desynchronizes output of the content by the first computer system and output of the content by the second computer system by pausing, rewinding, fast-forwarding, and/or a changing a volume of output of the content. In some embodiments, the first computer system synchronizes (e.g., in response to a request, “Sync with the living room,” such as described above with respect to FIG. 4B) output of the content by the first computer system with output of the content by the second computer system after the first computer system desynchronizes output of the content by the first computer system and output of the content by the second computer system.

In some embodiments, the first computer system is in communication (e.g., wired communication and/or wireless communication) with (or includes) one or more display generation components (e.g., a display screen, a projector, a head mounted display, and/or a touch-sensitive display). In some embodiments, outputting the indication of the first area of the environment includes displaying, via the one or more display generation components, the indication of the first area of the environment. In some embodiments, while displaying the indication of the first area of the environment, the first computer system detects an expiration of a period of time (e.g. such as described above with respect to FIG. 4B) (e.g., 1-360 seconds). In some embodiments, in response to detecting the expiration of the period of time, the first computer system ceases display of, via the one or more display generation components, the indication of the first area of the environment. In some embodiments, the first computer system ceases display of the indication of the first area of the environment in response to detecting an input from the subject or another subject different from the subject. In some embodiments, the first computer system ceases output of the indication of the second area of the environment in response to detecting an expiration of the period of time.

In some embodiments, the subject is a first subject. In some embodiments, outputting the indication of the first area (or the second area) of the environment includes, in accordance with a determination that a second subject (e.g., a user, a person, an animal, another computer system different from the computer system, a device, and/or an object) has a spatial relationship (e.g., is in front of, to the side of, behind, and/or diagonal to) with a third computer system (e.g., 400) (e.g., a watch, a phone, a tablet, a fitness tracking device, a processor, a head-mounted display (HMD) device, a communal device, a media device, a speaker, a television, an electronic device, and/or a personal computing device), outputting, via the third computer system, the indication of the first area of the environment. In some embodiments, outputting the indication of the first area (or the second area) of the environment includes, in accordance with a determination that the second subject has the spatial relationship with a fourth computer system (e.g., another computer system in living room 402, such as described above with respect to FIG. 4B) (e.g., a watch, a phone, a tablet, a fitness tracking device, a processor, a head-mounted display (HMD) device, a communal device, a media device, a speaker, a television, an electronic device, and/or a personal computing device) (and/or does not have the spatial relationship with the third computer system), outputting, via the fourth computer system, the indication of the first area of the environment (e.g., with or without outputting, via the third computer system, the indication of the first area of the environment). In some embodiments, the fourth computer system is different (and/or separate) from the third computer system. In some embodiments, the second subject is different from the first subject. In some embodiments, outputting the indication of the first area (or the second area) of the environment includes, in accordance with a determination that the second subject has the spatial relationship with the third computer system and the fourth computer system, outputting, via the third computer system and the fourth computer system, the indication of the first area of the environment.

In some embodiments, the first computer system outputs the content in a first modality (e.g., visual content, such as described above with respect to FIG. 4B) (e.g., visual modality and/or audio modality). In some embodiments, the second computer system outputs the content in a second modality (e.g., audio content, such as described above with respect to FIG. 4B) (e.g., visual modality and/or audio modality) different from the first modality (e.g., with or without outputting the content in the first modality). In some embodiments, the first computer system and the second computer system output the content in the same modality. In some embodiments, the first computer system outputs the content in more modalities than the second computer system or vice versa.

In some embodiments, the first computer system outputs the content in a first modality (e.g., visual content, such as described above with respect to FIG. 4B) (e.g., visual modality and/or audio modality). In some embodiments, the second computer system outputs the content in the first modality. In some embodiments, the first computer system and the second computer system outputs the content in the first modality and a second modality different from the first modality.

In some embodiments, the first computer system and the second computer system are positioned within an environment (e.g., a physical environment, a virtual environment, a home, an office building, and/or a school) (e.g., such as described above with respect to FIG. 4A). In some embodiments, the environment corresponds to, is associated with, and/or is managed by a logical environment (e.g., as described above). In some embodiments, the first computer system and the second computer system are included in the logical environment. In some embodiments, the first computer system is positioned in a first environment, and the second computer system is positioned in a second environment different from the first environment. In some embodiments, the first environment is managed by a different logical environment than the second environment.

In some embodiments, the subject is a first subject. In some embodiments, before receiving the indication that the first subject caused output of the content on the second computer system (e.g., and while not outputting the first content), the first computer system detects (or receives an indication of) an input (e.g., to output in the garage, such as described above with respect to FIG. 4A) (e.g., tap input, swipe input, voice command, and/or eye gaze) corresponding to (e.g., directed to, related to, and/or associated with) a request to output the content, wherein the input, corresponding to the request to output the content, is from (and/or corresponds to) a second subject (e.g., 424) different from the first subject (e.g., the first computer system detects that the second subject performed the input and/or the first computer system associated the input with the second subject). In some embodiments, the input corresponding to the request to output the content is detected via one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a gyroscope, an inertial measurement unit, a global positioning system, a motion sensor, a sensor, a mouse, a keyboard, a touchpad, and/or a touch-sensitive surface) in communication with and/or included in the first computer system. In some embodiments, in response to detecting the input corresponding to the request to output the content, the first computer system outputs, via the one or more output devices, the content (e.g., such as described above with respect to FIG. 4B). In some embodiments, the first computer system initiates output of the content in response to detecting a context in the environment. In some embodiments, the first computer system ceases output of the content in response to detecting that the first subject and/or the second subject performed an input corresponding to a request to cease output of the content. In some embodiments, the first subject and the second subject are registered with the first computer system. In some embodiments, the indication of the first area of the environment is output because a different subject requested output by the first computer system and the second computer system.

In some embodiments, before receiving the indication that the subject caused output of the content on the second computer system, the first computer system detects (or receives an indication of) an input (e.g., such as described above with respect to FIG. 4B) (e.g., tap input, swipe input, voice command, and/or eye gaze) corresponding to (e.g., directed to, related to, and/or associated with) a request to output the content, wherein the input, corresponding to the request to output the content, is from (and/or corresponds to) the subject (e.g., the first computer system detects that the subject performed the input and/or the first computer system associated the input with the subject). In some embodiments, the input corresponding to the request to output the content is detected via one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a gyroscope, an inertial measurement unit, a global positioning system, a motion sensor, a sensor, a mouse, a keyboard, a touchpad, and/or a touch-sensitive surface) in communication with and/or included in the first computer system. In some embodiments, in response to detecting the input corresponding to the request to output the content, the first computer system outputs, via the one or more output devices, the content. In some embodiments, the first computer system outputs the content with a different set of characteristics than output of the content by the second computer system. In some embodiments, output of the content by the first computer system and the second computer system are synchronized. In some embodiments, output of the content by the first computer system is delayed with respect to the output of the content by the second computer system. In some embodiments, the indication of the first area of the environment is output because the same subject requested output by the first computer system and the second computer system.

In some embodiments, the first computer system outputs a visual component (e.g., video of baseball game, such as described above with respect to FIG. 4A) (e.g., video and/or photography content) of the content. In some embodiments, the second computer system output an audio component (e.g., audio of a baseball game, such as described above with respect to FIG. 4B) of the content without outputting the visual component of the content. In some embodiments, the first computer system outputs the visual component and the audio component of the content. In some embodiments, the first computer system outputs the visual component of content and not the audio component of the content. In some embodiments, the second computer system outputs the audio component and the visual component of the content. In some embodiments, both the first computer system and the second computer system output the visual component and the audio component of the content.

In some embodiments, the first computer system outputs an audio component (e.g., such as described above with respect to FIGS. 4A-4B) of the content without outputting a visual component of the content. In some embodiments, the second computer system outputs the visual component (e.g., video and/or photography content) the content (and does not output the audio component of the content). In some embodiments, the first computer system does not output the visual component of the content. In some embodiments, the second computer system outputs the audio component of the content.

In some embodiments, after (or before or while) outputting the indication of the first area of the environment, the first computer system receives (e.g., from another computer system external to the first computer system and/or a subject) an indication that the subject caused (or is causing or will cause) the content to cease being output on the second computer system (e.g., Sarah exited and/or stopped listening, such as described above with respect to FIG. 4B). In some embodiments, the first computer system receives, from the second computer system, the indication that the subject caused the content to cease being output on the second computer system. In some embodiments, the first computer system receives, from another computer system different from the first computer system and the second computer system, the indication that the subject caused the content to cease being output on the second computer system. In some embodiments, in response to receiving the indication that the subject caused the content to cease being output on the second computer system, the first computer system forgoes output of an indication that the subject caused the content to cease being output on the second computer system. In some embodiments, in response to receiving the indication that the subject caused the content to cease being output on the second computer system, the first computer system outputs an indication that the second computer system is no longer outputting the content. In some embodiments, the first computer system ceases output of the indication of the first area or the second area of the environment in response to receiving the indication that the subject caused the content to cease being output on the second computer system. In some embodiments, another subject different from the subject caused the second computer system to cease output of the content.

In some embodiments, after (or before or while) outputting the indication of the first area of the environment, the first computer system receives (e.g., from another computer system external to the first computer system and/or a subject) an indication (e.g., “Sarah has exited the session,” such as described above with respect to FIG. 4B) that the subject caused (or is causing or will cause) the content to cease being output on the second computer system. In some embodiments, the first computer system receives, from the second computer system, the indication that the subject caused the content to cease being output on the second computer system. In some embodiments, the first computer system receives, from another computer system different from the first computer system and the second computer system, the indication that the subject caused the content to cease being output on the second computer system. In some embodiments, in response to receiving the indication that the subject caused the content to cease being output on the second computer system, the first computer system outputs (e.g., visually and/or audibly), via the one or more output devices, an indication (e.g., a graphical indication and/or a textual indication) that the subject caused the content to cease being output on the second computer system. In some embodiments, the first computer ceases outputting the indication of the first area or the second area of the environment as a part of outputting the indication that the subject caused the content to cease being output on the second computer system. In some embodiments, in response to receiving an indication that another subject different from the subject caused the content to cease being output on the second computer system, the first computer system outputs another indication that the other subject caused the content to cease being output on the second computer system.

Note that details of the processes described above with respect to process 500 (e.g., FIG. 5) are also applicable in an analogous manner to other processes described herein. For example, process 600 optionally includes one or more of the characteristics of the various processes described above with reference to process 500. For example, causing output of content at a first location of process 600 can occur while outputting an indication of the first area of the environment of process 500. For brevity, these details are not repeated herein.

FIG. 6 is a flow diagram illustrating a process (e.g., process 600) for causing output of content at different locations in accordance with some embodiments. Some operations in process 600 are, optionally, combined, the orders of some operations are, optionally, changed, and some operations are, optionally, omitted.

As described below, process 600 provides an intuitive way for causing output of content at different locations in accordance with some embodiments. Process 600 reduces the cognitive burden on a user, thereby creating a more efficient human-machine interface. For battery-operated computing devices, enabling a user to interact with such devices faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently.

In some embodiments, process 600 is performed at a first computer system (e.g., 436 and/or 460) (e.g., a watch, a phone, a tablet, a fitness tracking device, a processor, a head-mounted display (HMD) device, a communal device, a media device, a speaker, a television, an electronic device, and/or a personal computing device) that is in communication (e.g., wired and/or wireless communication) with (or includes) one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface).

The first computer system detects (602), via the one or more input devices, an input (e.g., 405d) (e.g., a voice command, tap input, swipe input, and/or air gesture) that corresponds to (e.g., directed to, at a location of, related to, and/or associated with) a subject (e.g., 484) (e.g., an individual, a subject that is registered with the first computer system, and/or a subject that is not registered with the first computer system). In some embodiments, the subject is a user, a person, an animal, another computer system different from the computer system, or a device.

In response to (604) detecting the input that corresponds to the subject, in accordance with a determination that the subject most recently interacted (e.g., performed an input, touched, held, gazed at, and/or faced) with a second computer system (e.g., 472) (e.g., within a predefined period of time, such as 5-30 seconds) at a first location (e.g., bedroom, such as described above with respect to FIGS. 4D-4E) (e.g., a bedroom, a kitchen, a location in a physical environment, and/or a location in a virtual environment), the first computer system causes (606) output of content (e.g., audibly output content and/or visually output content) at the first location, wherein the second computer system is different from the first computer system. In some embodiments, the second computer system is a watch, a phone, a tablet, a fitness tracking device, a processor, a head-mounted display (HMD) device, a communal device, a media device, a speaker, a television, an electronic device, and/or a personal computing device. In some embodiments, as part of causing output of the content at the first location, the first computer system does not cause output of the content at another location different from the first location. In some embodiments, the first computer system is not positioned at the first location. In some embodiments, causing output of the content at the first location includes causing output of the content by the second computer system. In some embodiments, causing output of the content at the first location includes causing output of the content by another computer system different from the first computer system and/or the second computer system.

In response to (604) detecting the input that corresponds to the subject, in accordance with a determination that the subject most recently (e.g., within the predefined period of time) interacted with (e.g., performed an input, touched, held, gazed at, and/or faced) a third computer system (e.g., a television in the bedroom and/or a communal device in the bedroom, such as described above with respect to FIG. 4E) (e.g., and not the second computer system) at a second location, the first computer system causes (608) output (e.g., audibly output content and/or visually output content) of the content at the second location (e.g., without causing output of the content at the first location), wherein the third computer system is different from the first computer system and the second computer system, and wherein the second location is different from the first location. In some embodiments, the first computer system is not positioned at the second location. In some embodiments, the third computer system is a watch, a phone, a tablet, a fitness tracking device, a processor, a head-mounted display (HMD) device, a communal device, a media device, a speaker, a television, an electronic device, and/or a personal computing device. In some embodiments, the first computer system is in communication with the second computer system and/or the third computer system. In some embodiments, the first computer system causes the second computer system and/or the third computer to output the content corresponding to the input. In some embodiments, the first computer system, the second computer system, and the third computer system are different types of computer systems. In some embodiments, the first computer system, the second computer system, and the third computer system are the same types of computer systems. In some embodiments, causing output of the content at the second location includes causing output of the content by the third computer system. In some embodiments, causing output of the content at the second location includes causing output of the content by another computer system different from the first computer system, the second computer system, and/or the third computer system. Providing improved feedback (such as by causing output of content at a location that is the most recent location of a targeted recipient) enhances the operability of the device by reducing accidental and mistaken inputs, reducing energy usage by the device. Performing an operation when a set of conditions has been met without requiring further user input (such as by causing output of content at a location that is the most recent location of a targeted recipient) enhances the operability of the device by reducing unnecessary inputs and/or steps to navigate through different user interfaces or sets of controls, reducing energy usage by the device.

In some embodiments, the input that corresponds to the subject includes an indication (e.g., “Sarah,” such as described above with respect to FIG. 4D) (e.g., a name, symbol, a number, contact information, an identifier, and/or an identification) of the subject. In some embodiments, the indication of the subject includes a description of the subject. In some embodiments, the indication of the subject includes a location of the subject.

In some embodiments, the subject is a first subject. In some embodiments, the input that corresponds to the first subject is performed by a second subject (e.g., 424) (e.g., a user, a person, an animal, another computer system different from the computer system, a device, and/or an object) different from the first subject (e.g., the second subject requested an operation be performed with respect to the first subject). In some embodiments, both the second subject and the first subject are registered with the first computer system.

In some embodiments, the input that corresponds to the subject includes an indication (e.g., “this is a great game,” such as described above with respect to FIG. 4D) of the content. In some embodiments, the indication of the content is a title of the content. In some embodiments, the indication of the content includes a summary of the content (e.g., “the game is intense,” such as described above with respect to FIG. 4D). In some embodiments, the indication of the content includes a description of the content (e.g., “players are making amazing shots,” such as described above with respect to FIG. 4D). In some embodiments, the indication of the content does not explicitly reference the content (e.g., “this is awesome,” such as described above with respect to FIG. 4D).

In some embodiments, the input that corresponds to the subject includes a request (e.g., “Tell,” such as described above with respect to FIG. 4D) to output the content. In some embodiments, the input includes a request for a particular computer system to output the content (e.g., on the bedroom tv, such as described above with respect to FIG. 4D). In some embodiments, the request does not include an indication of a computer system (e.g., “let Sarah know we’re watching a thriller,” such as described above with respect to FIG. 4D). In some embodiments, the input includes a request to output the content with one or more characteristics, such as volume, speed, a location within the content, and/or length of time (e.g., such as described above with respect to FIG. 4D). In some embodiments, the input that corresponds to the subject includes a request to output a particular portion of the content (e.g., the replay of that goal, such as described above with respect to FIG. 4D). In some embodiments, the input includes a request to output the content at a particular time (e.g., when Sarah gets home, such as described above with respect to FIG. 4D).

In some embodiments, the content is a recording (e.g., a recording of John’s voice, such as described above with respect to FIG. 4E) (e.g., a video recording and/or an audio recording) of the input that corresponds to (e.g., directed to, related to, and/or associated with) the subject. In some embodiments, the first computer system records the input. In some embodiments, another computer system different from the first computer system records the input that corresponds to the subject. In some embodiments, the content is a recording that corresponds to another subject other than the subject.

In some embodiments, the content includes a representation (e.g., an audio and/or visual representation of the message, such as described above with respect to FIG. 6E) (e.g., a graphical representation, audio representation, and/or textual representation) of the input that corresponds to the subject. In some embodiments, the content is a description of the input. In some embodiments, the content includes a representation of the subject.

In some embodiments, the input that corresponds to the subject does not include an indication (e.g., does not include the bedroom, such as described above with respect to FIG. 4D) (and/or reference) of a location of the subject. In some embodiments, the input that corresponds to the subject includes an indication of a location of the subject. In some embodiments, the input that corresponds to the subject includes an indication of and/or reference to the subject. In some embodiments, the input that corresponds to the subject includes an indication of the content.

In some embodiments, the input that corresponds to the subject does not include an indication (e.g., such as described above with respect to FIG. 4D) (and/or reference) of the second computer system. In some embodiments, the input that corresponds to the subject does not include an indication (and/or reference) of the third computer system. In some embodiments, the input that corresponds to the subject includes an indication and/or reference of the second computer system or the third computer system. In some embodiments, the indication and/or reference of the second computer system or third computer system includes a location of the second computer system or the third computer system. In some embodiments, the indication and/or reference of the second computer system or third computer system includes a name and/or model of the second computer system or the third computer system.

In some embodiments, the second computer system is a different type of computer system than the third computer system (e.g., send to a television rather than computer system 472, such as described above with respect to FIG. 4E). In some embodiments, the second computer system and the third computer system are the same type of computer system. In some embodiments, the second computer system outputs the content in a different modality than the third computer system. In some embodiments, the second computer system outputs the content in the same modality as the third computer system.

In some embodiments, causing output of the content at the second location includes causing the third computer system to output the content (e.g., output by television, such as described above with respect to FIG. 4E) (and not the second computer system). In some embodiments, causing output of the content at the first location includes causing the second computer system to output the content and not the third computer system. In some embodiments, causing output of the content at the second location includes causing the third computer system and a fourth computer system, separate from the first computer system, the second computer system, and/or the third computer system, to output the content.

In some embodiments, causing output of the content at the second location includes causing a fourth computer system (e.g., television, such as described above with respect to FIG. 4E), different from the third computer system (and/or the first computer system and/or the second computer system), to output the content. In some embodiments, the fourth computer system is a phone, a watch, a tablet, a fitness tracking device, an accessory device, a processor, a head-mounted display (HMD) device, a communal device, a media device, a speaker, a television, an electronic device, a camera, and/or a personal computing device. In some embodiments, the fourth computer system is positioned at the second location. In some embodiments, the fourth computer system is positioned at a location different from the fourth location. In some embodiments, the first computer system causes the fourth computer system to output the content because the third computer system is not able to output the content. In some embodiments, the first computer system causes the fourth computer system to output the content because the third computer system is outputting different content.

In some embodiments, the fourth computer system is a different type (e.g., television versus speaker, such as described above with respect to FIG. 4E) of computer system than the third computer system. In some embodiments, the fourth computer system is the same type of computer system as the third computer system. In some embodiments, the fourth computer system and the third computer system are registered with a common user account. In some embodiments, the fourth computer system outputs content in a different modality than the third computer system. In some embodiments, the fourth computer system outputs content in the same modality as the third computer system.

In some embodiments, before causing output of the content at the first location, the first computer system receives (and/or detects) an indication (e.g., Sarah’s location, such as described above with respect to FIG. 4E), of a location of the subject. In some embodiments, the location of the subject is a current location of the subject. In some embodiments, before causing output of the content at the second location, the computer system receives (and/or detects) the indication of the location of the subject. In some embodiments, the first computer system receives the location of the subject in conjunction with detecting the input that corresponds to the subject. In some embodiments, the first computer system receives the location of the subject after detecting the input that corresponds to the subject. In some embodiments, the first computer system receives the location of the subject from a computer system different from the second computer system and the third computer system. In some embodiments, the first computer system determines and/or detects the location of the subject. In some embodiments, the indication of the location of the subject is received from another computer system separate from the first computer system, the second computer system, and/or the third computer system. In some embodiments, the other computer system is an accessory device, such as a motion sensor, a camera, and/or a microphone, a personal device of the subject, and/or a GPS.

In some embodiments, the first computer system is in communication (e.g., wireless and/or wired communication) with (and/or includes) one or more cameras (e.g., a periscope camera, a telephoto camera, a wide-angle camera, and/or an ultra-wide-angle camera). In some embodiments, the indication of the location of the subject is received from the one or more cameras (e.g., based on images of Sarah, such as described above with respect to FIG. 4E) (e.g., the one or more cameras capture the subject and send, to the first computer system, the indication of the location of the subject based on capturing the subject). In some embodiments, the first computer system detects the location of the subject via the one or more cameras. In some embodiments, the indication of the location of the subject is an identification of the location of the subject (e.g., determined by the one or more cameras). In some embodiments, the indication of the location of the subject is an image and/or a video of the subject.

In some embodiments, in response to detecting the input that corresponds to the subject and in accordance with a determination that the subject has not interacted with a computer system within a period of time (e.g., 5-60 minutes) of the first computer system detecting the input that corresponds to the subject, the first computer system forgoes causing output of the content (e.g., not interacted for the last ten minutes, such as described above with respect to FIG. 4E). In some embodiments, in response to detecting that the input that corresponds to the subject and in accordance with a determination that the subject has not interacted with a computer system within the period of time, the first computer system causes a computer system that the subject most recently interacted with to output the content. In some embodiments, in response to detecting the input that corresponds to the subject and in accordance with a determination that the subject has not interacted with a computer system within the period of time of the first computer system detecting the input that corresponds to the subject, the computer system causes a default computer system (e.g., the first computer system, the second computer system, the third computer system, the fourth computer system, another computer system, and/or a personal device of the subject) to output the content.

In some embodiments, the first computer system is in communication (e.g., wired communication and/or wireless communication) with (and/or includes) one or more output devices (e.g., a display generation component, an audio generation component, and/or a haptic generation component). In some embodiments, in response to detecting the input that corresponds to the subject and in accordance with a determination that the subject has not interacted with a computer system within a period of time (e.g., 5-60 minutes) of the first computer system detecting the input that corresponds to the subject, the first computer system outputs, via the one or more output devices, an indication (e.g., “Message to Sarah could not be delivered,” such as described above with respect to FIG. 4E) (e.g., a graphical indication and/or an audio indication) that the content is not output. In some embodiments, the first computer system outputs the indication that the content is not output while the first computer system outputs other content. In some embodiments, the first computer system suspends output of current content to output the indication that the content is not output.

In some embodiments, in response to detecting the input that corresponds to the subject and in accordance with a determination that a computer system was interacted with (e.g., performed an input, touched, held, gazed at, and/or faced) at a location that does not include a computer system capable of outputting the content, the first computer system forgoes causing output of the content (e.g., such as described above with respect to FIG. 4E). In some embodiments, in response to detecting the input that corresponds to the subject and in accordance with a determination that a computer system was interacted with at a location that does not include a computer system capable of outputting the content, the first computer system causes a computer system that the subject most recently interacted with that is capable of outputting the content to output the content. In some embodiments, in response to detecting the input that corresponds to the subject and in accordance with a determination that a computer system was interacted with at a location that does not include a computer system capable of outputting the content, the computer system causes a default computer system (e.g., the first computer system, the second computer system, the third computer system, the fourth computer system, another computer system, and/or a personal device of the subject) to output the content.

In some embodiments, in response to detecting the input that corresponds to the subject and in accordance with a determination that a computer system was interacted with (e.g., performed an input, touched, held, gazed at, and/or faced) at a location that does not include a computer system capable of outputting the content, the first computer system causes a fourth computer system (e.g., default computer system, such as described above with respect to FIG. 4E) (e.g., and not the first computer system, the second computer system, and/or the third computer system) to output the content. In some embodiments, the fourth computer system is a watch, a phone, a tablet, a fitness tracking device, a processor, a head-mounted display (HMD) device, a communal device, a media device, a speaker, a television, an electronic device, and/or a personal computing device. In some embodiments, the fourth computer system is a default computer system (e.g., a computer system designated to output content when other computer systems are not available or present). In some embodiments, the determination that a computer system is not capable of outputting the content includes a determination that a type of content to be output (e.g., audio, video, and/or haptic) is different from a type of output device (e.g., speaker, video, and/or haptic) in communication with and/or included in the computer system.

In some embodiments, in response to detecting the input that corresponds to the subject and in accordance with a determination that the subject most recently interacted with (e.g., performed an input, touched, held, gazed at, and/or faced) a fourth computer system (e.g., computer system in the kitchen, such as described above with respect to FIG. 4E) at a third location and that the subject is at a fourth location, the first computer system causes output of the content (e.g., audibly output content and/or visually output content) at the fourth location, wherein the fourth location is different from the third location. In some embodiments, the fourth computer system is a watch, a phone, a tablet, a fitness tracking device, a processor, a head-mounted display (HMD) device, a communal device, a media device, a speaker, a television, an electronic device, and/or a personal computing device. In some embodiments, as part of causing output of the content at the fourth location, the first computer system does not cause output of the content at another location different from the fourth location, such as the third location. In some embodiments, the first computer system is not positioned at the fourth location. In some embodiments, causing output of the content at the fourth location includes causing output of the content by another computer system different from the fourth computer system and/or the first computer system. In some embodiments, in response to detecting the input that corresponds to the subject and in accordance with a determination that the subject most recently interacted with (e.g., performed an input, touched, held, gazed at, and/or faced) a fifth computer system at a fifth location and that the subject is at a sixth location, causing output of content (e.g., audibly output content and/or visually output content) at the sixth location, wherein the sixth location is different from the first location and the fifth location. In some embodiments, the fifth computer system is a watch, a phone, a tablet, a fitness tracking device, a processor, a head-mounted display (HMD) device, a communal device, a media device, a speaker, a television, an electronic device, and/or a personal computing device. In some embodiments, as part of causing output of the content at the sixth location, the first computer system does not cause output of the content at another location different from the sixth location. In some embodiments, the first computer system is not positioned at the sixth location. In some embodiments, causing output of the content at the sixth location includes causing output of the content by a computer system different from the fifth computer system and/or the first computer system.

Note that details of the processes described above with respect to process 600 (e.g., FIG. 6) are also applicable in an analogous manner to other processes described herein. For example, process 700 optionally includes one or more of the characteristics of the various processes described above with reference to process 600. For example, causing output of content at the first location of process 600 can occur while outputting content at a third computer system of process 700. For brevity, these details are not repeated herein.

FIG. 7 is a flow diagram illustrating a process (e.g., process 700) for causing output of complimentary content in accordance with some embodiments. Some operations in process 700 are, optionally, combined, the orders of some operations are, optionally, changed, and some operations are, optionally, omitted.

As described below, process 700 provides an intuitive way for causing output of complimentary content in accordance with some embodiments. Process 700 reduces the cognitive burden on a user, thereby creating a more efficient human-machine interface. For battery-operated computing devices, enabling a user to interact with such devices faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently.

In some embodiments, process 700 is performed at a first computer system (e.g., 460) (e.g., a watch, a phone, a tablet, a fitness tracking device, a processor, a head-mounted display (HMD) device, a communal device, a media device, a speaker, a television, an electronic device, and/or a personal computing device).

While (702) a second computer system (e.g., 400) (e.g., a watch, a phone, a tablet, a fitness tracking device, a processor, a head-mounted display (HMD) device, a communal device, a media device, a speaker, a television, an electronic device, and/or a personal computing device) outputs (visually outputs and/or audibly outputs) first content (e.g., 412) (e.g., a television show, movie, song, video, and/or podcast), the first computer system detects (704) (e.g., detected via one or more cameras external to the first computer system and/or detected via one or more cameras of the first computer system) an attention of a subject (e.g., 424) (e.g., an individual, a subject registered with the first computer system and/or the respective computer system, and/or a subject who is not registered with the first computer system and/or the respective computer system). In some embodiments, the second computer system is the first computer system. In some embodiments, the second computer system is different from the first computer system.

While (702) the second computer system outputs first content, in response to (706) detecting the attention of the subject, in accordance with a determination that the attention of the subject is directed at (e.g., the subject is looking at, the subject is holding, the subject identifies, and/or the subject is facing) a third computer system (e.g., 436) (e.g., a watch, a phone, a tablet, a fitness tracking device, a processor, a head-mounted display (HMD) device, a communal device, a media device, a speaker, a television, an electronic device, and/or a personal computing device), the first computer system causes (708) the third computer system to output (e.g., by the third computer system and/or by another computer system different from the third computer system) second content (e.g., 432) that is complementary to the first content, wherein the third computer system is different from the first computer system and the second computer system. In some embodiments, causing the third computer system to output the second content includes causing the third computer system to display the second content.

While (702) the second computer system outputs first content, in response to (706) detecting the attention of the subject, in accordance with a determination that the attention of the subject is directed at (e.g., the subject is looking at, the subject is holding, the subject identifies, and/or the subject is facing) a fourth computer system (e.g., the other tablet, such as described above with respect to FIG. 4D) (e.g., a watch, a phone, a tablet, a fitness tracking device, a processor, a head-mounted display (HMD) device, a communal device, a media device, a speaker, a television, an electronic device, and/or a personal computing device), the first computer system causes (710) the fourth computer system to output (e.g., by the fourth computer system and/or by another computer system different from the fourth computer system) third content (e.g., history, such as described above with respect to FIG. 4D) (e.g., without causing the third computer system to output the second content) that is complimentary to the first content, wherein the fourth computer system is different from the first computer system, the second computer system, and the third computer system. In some embodiments, causing the fourth computer system to output the third content includes causing the fourth computer system to display the third content. In some embodiments, detecting the attention of the subject includes detecting that the subject is looking at a respective computer system (e.g., the third computer system or the fourth computer system), detecting that the subject is holding the respective computer system, detecting that the subject identifies the respective computer system in speech, and/or the subject is facing towards the respective computer system. In some embodiments, the attention of the subject is not directed at the fourth computer system while the attention of the subject is directed at the third computer system or vice versa. In some embodiments, the first computer system causes the third computer system and the fourth computer system to output fourth content that is complimentary to the first content in response to detecting the attention of the subject and in accordance with a determination that the attention of the subject is directed at the second computer system and the third computer system. In some embodiments, the third content is the second content. In some embodiments, the third content is different from the second content. Providing additional control options without cluttering the user interface with additional displayed controls (such as by causing output of content at a device with complimentary content that corresponds to user attention) enhances the operability of the device by reducing unnecessary inputs and/or steps to navigate through different user interfaces or sets of controls, reducing energy usage by the device. Providing improved feedback (such as by causing output of content at a device with complimentary content that corresponds to user attention) enhances the operability of the device by reducing accidental and mistaken inputs, reducing energy usage by the device. Performing an operation when a set of conditions has been met without requiring further user input (such as by causing output of content at a device with complimentary content that corresponds to user attention) enhances the operability of the device by reducing unnecessary inputs and/or steps to navigate through different user interfaces or sets of controls, reducing energy usage by the device.

In some embodiments, the determination that the attention of the subject is directed at the third computer system includes a determination that the attention of the subject is directed at the third computer system for a threshold amount of time (e.g., 60 seconds, such as described above with respect to FIGS. 4B-4C) (e.g., 0-180 seconds). In some embodiments, in response to detecting the attention of the subject and in accordance with a determination that the attention of the subject is directed at the third computer system for less than the threshold amount of time, the first computer system does not cause the third computer system to output the second content that is complementary to the first content.

In some embodiments, the second computer system outputs the first content in multiple modalities (e.g., visual modality and audio modality). In some embodiments, the third computer system outputs the second content in a single modality (e.g., visual, such as described above with respect to FIG. 4D) (e.g., visual modality or audio modality). In some embodiments, the second computer system outputs the first content in a single modality. In some embodiments, the third computer system outputs the second content in multiple modalities. In some embodiments, the second computer system and the third computer system output the respective content in the same modality or different modalities.

In some embodiments, the first content is different from the second content. In some embodiments, the first content is the same as the second content. In some embodiments, the second content includes the first content. In some embodiments, the first content includes the second content.

In some embodiments, the first content includes third content (e.g., current score, such as described above with respect to FIG. 4D). In some embodiments, the second content includes the third content. In some embodiments, there is not any overlap between the first content and the second content. In some embodiments, the first content includes content that is not included in the second content. In some embodiments, the second content includes content that is not included in the first content.

In some embodiments, the first content and the second content are mutually exclusive (e.g., there is no overlap in content and/or share no common content) (e.g., special trivia not included in baseball content 412, such as described above with respect to FIG. 4D). In some embodiments, the first content does not include content from the second content, and the second content does not include content from the first content.

In some embodiments, while causing the third computer system to output the second content, the first computer system detects that the attention (e.g., a gaze, body direction, speech of the subject and/or what object the subject is holding) of the subject is not directed at the third computer system (and/or receives an indication that the attention of the subject is not directed at the third computer system) (e.g., directed away, such as described above with respect to FIG. 4D). In some embodiments, in response to detecting that the attention of the subject is not directed at the third computer system, the first computer system ceases to cause the third computer system to output the second content. In some embodiments, the first computer system continues to cause the third computer system to output the second content in response to detecting that the attention of the subject is not directed at the third computer system. In some embodiments, the first computer system ceases to cause the third computer system to output the second content in response to detecting that the attention of the subject is not directed at the third computer system for a non-zero period of time.

In some embodiments, while causing the third computer system to output the second content, the first computer system detects that the attention (e.g., a gaze, body direction, speech of the subject and/or what object the subject is holding) of the subject is not directed at the third computer system (and/or receives an indication that the attention of the subject is not directed at the third computer system) (e.g., directed away, such as described above with respect to FIG. 4D). In some embodiments, in response to detecting the attention of the subject is not directed at the third computer system, the first computer system continues to cause the third computer system to output the second content.

In some embodiments, while causing the third computer system to output the second content (and/or after detecting that the attention of the subject is directed at the third computer system), the first computer system detects that the attention (e.g., a gaze, body direction, speech of the subject and/or what object the subject is holding) of the subject is directed at a fifth computer system (e.g., tablet, such as described above with respect to FIG. 4D), wherein the fifth computer system is different from the second computer system and third computer system (and/or the first computer system). In some embodiments, the fifth computer system and the third computer system are different types of computer systems. In some embodiments, the fifth computer system and the third computer system are the same type of computer system. In some embodiments, the third computer system and the fifth computer system are registered with a user, the first computer system, and/or the second computer system. In some embodiments, in response to detecting that the attention of the subject is directed at the fifth computer system (and not at the third computer system), the first computer system causes the fifth computer system to output the second content (e.g., such as described above with respect to FIG. 4D). In some embodiments, in response to detecting that the attention of the subject is directed at the fifth computer system, the first computer system ceases causing the third computer system to output the second content. In some embodiments, in response to detecting that the attention of the subject is directed at the fifth computer system, the first computer system continues causing the third computer system to output the second content.

In some embodiments, the third computer system and the fourth computer system are different types of computer systems (e.g., personal smartphone and hub device, such as described above with respect to FIG. 4D). In some embodiments, the third computer system and the fourth computer system are different models of the same type of computer system.

In some embodiments, the third computer system and the fourth computer system are the same type of computer system (e.g., both personal smartphones, such as described above with respect to FIG. 4D). In some embodiments, in response to detecting the attention of the subject and in accordance with a determination that the attention of the subject is not directed at a computer system (e.g., looking away, such as described above with respect to FIG. 4C), the first computer system forgoes causing a computer system (e.g., any computer system) to output content that is complementary to the first content. In some embodiments, in response to detecting the attention of the subject and in accordance with a determination that the attention of the subject is not directed at a computer system the first computer system causes a default computer system to output fourth content that is complementary to the first content. In some embodiments, the fourth content is based on what type of device the default computer system is. In some embodiments, the second computer system continues to output the first content when the determination is made that the attention of the subject is not directed at a computer system.

In some embodiments, after (or while) causing the third computer system to output the second content, the first computer system detects that the attention (e.g., gaze, body direction, and/or what computer system the subject is holding) of the subject is directed at the fourth computer system (e.g., and/or receives an indication that the attention of the subject is directed at the fourth computer system). In some embodiments, in response to detecting that the attention of the subject is directed at the fourth computer system and in accordance with a determination that the second computer system is not outputting content, the first computer system forgoes causing the fourth computer system to output content (e.g., does not send the message, such as described above with respect to FIG. 4D). In some embodiments, after (or while) causing the third computer system to output the second content, in response to detecting that the attention of the subject is directed at the fourth computer system, and in accordance with a determination that the second computer system is outputting content, the first computer system causes the fourth computer system to output content that is complementary to the content.

In some embodiments, the first computer system is in communication (e.g., wired and/or wireless communication) with (and/or includes) one or more cameras (e.g., a periscope camera, a telephoto camera, a wide-angle camera, and/or an ultra-wide-angle camera). In some embodiments, the attention of the subject is detected via the one or more cameras (e.g., such as described above with respect to FIG. 4D). In some embodiments, the one or more cameras are integrated within the first computer system. In some embodiments, the one or more cameras are external to the first computer system.

In some embodiments, the first computer system is in communication (e.g., wired and/or wireless communication) with (and/or includes) one or more microphones. In some embodiments, the attention of the subject is detected via the one or more microphones (e.g., such as described above with respect to FIG. 4D). In some embodiments, the one or more microphones are integrated with in the first computer system. In some embodiments, the one or more microphones are external to the first computer system.

In some embodiments, the second content includes (and/or is) a user interface object (e.g., 420b) (e.g., a virtual button, an icon, a widget, a control, and/or a window), that, when selected, causes (results in and/or generates) display of information related to the first content.

In some embodiments, the second content includes (and/or is) information (e.g., auxiliary, secondary, ancillary, and/or connected to) related to the first content (e.g., such as described above with respect to FIG. 4D). In some embodiments, the information changes as the first content changes. In some embodiments, the information is static (and/or does not change over time and/or as the first content changes). In some embodiments, a first portion of the information is static (and/or does not change over time and/or as the first content changes) and a second portion of the information changes as the first content changes.

In some embodiments, the third content is the second content (e.g., such as described above with respect to FIG. 4D).

In some embodiments, the third content is different from the second content (e.g., such as described above with respect to FIG. 4D).

Note that details of the processes described above with respect to process 700 (e.g., FIG. 7) are also applicable in an analogous manner to other processes described herein. For example, process 800 optionally includes one or more of the characteristics of the various processes described above with reference to process 700. For example, the content caused by the first device of process 800 can replace the content at a third computer system of process 700. For brevity, these details are not repeated herein.

FIG. 8 is a flow diagram illustrating a process (e.g., process 800) for outputting content related to other content in accordance with some embodiments. Some operations in process 800 are, optionally, combined, the orders of some operations are, optionally, changed, and some operations are, optionally, omitted.

As described below, process 800 provides an intuitive way for outputting content related to other content in accordance with some embodiments. Process 800 reduces the cognitive burden on a user, thereby creating a more efficient human-machine interface. For battery-operated computing devices, enabling a user to interact with such devices faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently.

In some embodiments, process 800 is performed at a computer system (e.g., 400, 436, and/or 460) (e.g., a watch, a phone, a tablet, a fitness tracking device, a processor, a head-mounted display (HMD) device, a communal device, a media device, a speaker, a television, an electronic device, and/or a personal computing device).

The computer system receives (802) (e.g., from another computer system external to the computer system and/or from a server external to the computer system) a request (e.g., to share concert content, such as described above with respect to FIG. 4F) to output (e.g., audibly output and/or visibly output) first content (e.g., a television show, movie, song, video, and/or podcast) on a set of one or more devices. In some embodiments, the set of one or more devices is positioned within an environment. In some embodiments, the request to output content is received from another computer system that is not positioned within the environment. In some embodiments, the request to output content is received from another computer system that is positioned within the environment. In some embodiments, the computer system receives the request to output the first content while another computer system, different from the computer system, outputs the first content. In some embodiments, the set of one or more devices is associated with a location, an environment, an entity, and/or an object, such as a home. In some embodiments, each device of the set of one or more devices are accessory devices within a location and/or an environment. In some embodiments, the set of one or more devices are established as a group of devices for a location and/or an environment. In some embodiments, the request to output the first content on the set of one or more devices is a request to output the first content at the location, the environment, and/or the group of devices. In some embodiments, the set of one or more devices is associated with a user account. In some embodiments, the request to output the first content on the set of one or more devices is a request to output the first content to the user account.

In response to (804) receiving the request to output the first content on the set of one or more devices, in accordance with a determination that a first device (e.g., 400) (e.g., a watch, a phone, a tablet, a fitness tracking device, a processor, a head-mounted display (HMD) device, a communal device, a media device, a speaker, a television, an electronic device, and/or a personal computing device) of the set of one or more devices satisfies a set of one or more criteria (e.g., more suited, best suited, most appropriate, opportune, most fitting, most pertinent, and/or most suitable) with respect to output of the first content (e.g., relative to other devices included in the set of one or more devices), the computer system causes (806) the first device of the set of one or more devices to output (e.g. visually and/or audibly output) second content (e.g., 468) related to the first content (e.g., without causing another device of the set of one or more devices to output the second content and/or any content related to the first content).

In response to (804) receiving the request to output the first content on the set of one or more devices, in accordance with a determination that a second device (e.g., 436) (e.g., a watch, a phone, a tablet, a fitness tracking device, a processor, a head-mounted display (HMD) device, a communal device, a media device, a speaker, a television, an electronic device, and/or a personal computing device) of the set of one or more devices satisfies the set of one or more criteria with respect to output of the first content (e.g., relative to other devices included in the set of one or more devices), the computer system causes (808) the second device of the set of one or more devices to output the second content related to the first content (e.g., without causing another device of the set of one or more devices to output the second content and/or any content related to the first content), wherein the first device is different from the second device. In some embodiments, in response to receiving the request to output the first content on the set of one or more devices and in accordance with a determination that no device of the set of one or more devices satisfies the set of one or more criteria with respect to output of the first content (e.g., relative to other devices included in the set of one or more devices), the computer system forgoes causing output of the second content related to the first content. In some embodiments, in response to receiving the request to output the first content on the set of one or more devices and in accordance with a determination that the first device and the second device satisfy the set of one or more criteria with respect to output of the first content (e.g., relative to other devices included in the set of one or more devices), the computer system causes the first device and the second device to output the second content. Providing additional control options without cluttering the user interface with additional displayed controls (such as by selectively outputting content to a device that satisfies criteria) enhances the operability of the device by reducing unnecessary inputs and/or steps to navigate through different user interfaces or sets of controls, reducing energy usage by the device. Providing improved feedback (such as by selectively outputting content to a device that satisfies criteria) enhances the operability of the device by reducing accidental and mistaken inputs, reducing energy usage by the device. Performing an operation when a set of conditions has been met without requiring further user input (such as by selectively outputting content to a device that satisfies criteria) enhances the operability of the device by reducing unnecessary inputs and/or steps to navigate through different user interfaces or sets of controls, reducing energy usage by the device.

In some embodiments, the determination that the first device of the set of one or more devices satisfies the set of one or more criteria with respect to output of the first content includes a determination that the content includes audio content (e.g., concert audio, such as described above with respect to FIG. 4F) (e.g., the set of one or more criteria includes a criterion that is satisfied when the content includes audio content). In some embodiments, the content includes the audio content and visual content that is displayed (e.g., images and/or photos). In some embodiments, the determination that the first device of the set of one or more devices satisfies the set of one or more criteria with respect to the output of the first content includes a determination that the content does not include visual content that is displayed. In some embodiments, the determination that the second device of the set of one or more devices satisfies the set of one or more criteria with respect to output of the first content includes a determination that the content includes audio content.

In some embodiments, the determination that the first device satisfies the set of one or more criteria with respect to output of the first content includes a determination that the content includes visual content (e.g., display the concert content, such as described above with respect to FIG. 4F) (e.g., a still image and/or photo). In some embodiments, the determination that the first device of the set of one or more devices satisfies the set of one or more criteria with respect to output of the first content includes a determination that the content does not include audio content. In some embodiments, the determination that the second device satisfies the set of one or more criteria with respect to output of the first content includes a determination that the content includes visual content.

In some embodiments, the determination that the first device satisfies the set of one or more criteria with respect to output of the first content includes a determination that the first content includes audio content and visual content (e.g., one or more still photos and/or one or more videos) (e.g., such as described above with respect to FIG. 4F). In some embodiments, the audio content corresponds to and/or is synchronized with the visual content. In some embodiments, the audio content does not correspond to and/or is not synchronized with the visual content. In some embodiments, the determination that the second device satisfies the set of one or more criteria with respect to output of the first content includes a determination that the first content includes audio content and visual content.

In some embodiments, the determination that the first device satisfies the set of one or more criteria with respect to output of the first content includes a determination that a subject (e.g., a user, a person, an animal, another computer system different from the computer system, a device, and/or an object) is positioned in front of (e.g., faces, opposite to, and/or aligned with) the first device (e.g., John is in front of computer system 400, such as described above with respect to FIG. 4F). In some embodiments, the determination that the second device satisfies the set of one or more criteria with respect to output of the first content includes a determination that a subject (e.g., a user, a person, an animal, another computer system different from the computer system, a device, and/or an object) is positioned in front of the second device.

In some embodiments, the determination that the first device satisfies the set of one or more criteria with respect to output of the first content includes a determination that the current time is a specific time (e.g., morning, noon, night, 1:00 p.m., and/or 7:00 p.m.) (e.g., time of day, such as described above with respect to FIG. 4F). In some embodiments, the specific time is manually set by a user of the computer system and/or the first device. In some embodiments, the specific time is automatically set by the first computer system based on usage (e.g., watching history and/or requests to output the second content). In some embodiments, the determination that the second device satisfies the set of one or more criteria with respect to output of the first content includes a determination that the current time is a specific time.

In some embodiments, the determination that the first device satisfies the set of one or more criteria with respect to output of the first content includes a determination that the request corresponds to a first individual (e.g., a user of the first computer system and/or a subject) (e.g., intended recipient, such as described above with respect to FIG. 4F). In some embodiments, the subject includes a person, an animal, another computer system different from the first computer system, a device, and/or an object. In some embodiments, the determination that the second device satisfies the set of one or more criteria with respect to output of the first content includes a determination that the request corresponds to the first individual.

In some embodiments, the determination that the first device satisfies the set of one or more criteria with respect to output of the first content includes a determination that the first device corresponds to (e.g., is owned by, is logged into as, and/or is associated with) a first individual (e.g., a user of the first computer system and/or a subject) (e.g., based on images, and/or interest to the concert, such as described above with respect to FIG. 4F). In some embodiments, the subject includes a person, an animal, another computer system different from the first computer system, a device, and/or an object. In some embodiments, the determination that the first device corresponds to the first individual includes a determination that the first individual is most interested in viewing the content (e.g., is content related to the first individual and/or has a high rate of interaction).

In some embodiments, causing the first device of the set of one or more devices to output the second content related to the first content includes causing display of a notification (e.g., 456).

In some embodiments, in response to receiving the request to output the first content on the set of one or more devices and in accordance with the determination that the first device of the set of one or more devices satisfies the set of one or more criteria with respect to output of the first content, the computer system forgoes causing the second device of the set of one or more devices to output the second content related to the first content (e.g., no other computer system outputs the concert content, such as described above with respect to FIG. 4F). In some embodiments, in response to receiving the request to output the first content on the set of one or more devices and in accordance with the determination that the second device of the set of one or more devices satisfies the set of one or more criteria with respect to output of the first content, the computer system forgoes causing the first device of the set of one or more devices to output the second content related to the first content

In some embodiments, the set of one or more devices are positioned within an environment (e.g., a common, a physical, a logical, and/or a virtual environment) (e.g., such as described above with respect to 4F).

In some embodiments, the first device outputs third content (e.g., 412) before (and/or while) receiving the request to output the first content on the set of one or more devices. In some embodiments, causing the first device of the set of one or more devices to output the second content related to the first content includes causing the first device to cease output of the third content (e.g., such as described above with respect to 4G). In some embodiments, the second device outputs the third content before (and/or while) the computer system receives the request to output the first content on the set of one or more devices. In some embodiments, causing the second device of the set of one or more devices to output the second content related to the first content includes causing the second device to cease output of the third content.

In some embodiments, the first device displays third content (e.g., 412) while the computer system receives the request to output the first content on the set of one or more devices. In some embodiments, causing the first device of the set of one or more devices to output the second content includes causing the first device of the set of one or more devices to output the second content overlaid on (e.g., on top of and/or obscuring part of) the third content.

In some embodiments, in response to receiving the request to output the first content on the set of one or more devices, in accordance with the determination that the first device of the set of one or more devices satisfies the set of one or more criteria with respect to output of the first content, the computer system forgoes causing a third device (e.g., 436 and/or 472) (e.g., a watch, a phone, a tablet, a fitness tracking device, a processor, a head-mounted display (HMD) device, a communal device, a media device, a speaker, a television, an electronic device, and/or a personal computing device) of the set of one or more devices to output the second content related to the first content, wherein the third device is separate from the first device and the second device. In some embodiments, in response to receiving the request to output the first content on the set of one or more devices, in accordance with the determination that the second device of the set of one or more devices satisfies the set of one or more criteria with respect to output of the first content, the computer system forgoes causing the third device of the set of one or more devices to output the second content related to the first content (e.g., such as described above with respect to FIG. 4G). In some embodiments, in response to receiving the request to output the first content on the set of one or more devices and in accordance with a determination that the third device satisfies the set of one or more criteria with respect to output of the first content, causing the third device of the set of one or more devices to output the second content related to the first content.

In some embodiments, in response to receiving the request to output the first content on the set of one or more devices and in accordance with a determination that the first device and the second device of the set of one or more devices do not satisfy the set of one or more criteria, the computer system forgoes causing the second device and the first device from outputting the second content related to the first content (e.g., do not output when the smart thermostat nor smart refrigerator can output the notification, such as described above with respect to FIG. 4G). In some embodiments, in response to receiving the request to output the first content on the set of one or more devices and in accordance with a determination that the first device and the second device of the set of one or more devices do not satisfy the set of one or more criteria, the computer system forgoes causing any device (e.g., a device separate and/or different from the first device and/or the second device) from outputting the second content related to the first content.

In some embodiments, causing the first device of the set of one or more devices to output the second content includes causing the first device to output the second content in a first modality (e.g., concert audio, such as described above with respect to FIG. 4G) (e.g., audio and/or haptic) and a second modality (e.g., concert video, such as described above with respect to FIG. 4G) (e.g., video and/or light). In some embodiments, the second modality is different from the first modality.

In some embodiments, the second content is the first content (e.g., such as described above with respect to FIG. 4G).

Note that details of the processes described above with respect to process 800 (e.g., FIG. 8) are also applicable in an analogous manner to the processes described herein. For example, process 500 optionally includes one or more of the characteristics of the various processes described herein with reference to process 800. For example, the indication of the first area of the environment of process 500 can occur while outputting the content caused by the first device of process 800. For brevity, these details are not repeated herein.

In order to provide clarification, the aforementioned description has been explained using particular embodiments and examples. At least some of these particular embodiments and examples can be found in the accompanying figures. However, such embodiments and examples should not be construed as restricting the disclosure or as exhaustive unless explicitly indicated otherwise. Without going beyond this description, a person of ordinary skill in the art can make changes and/or alterations in light of the aforementioned description.

In some embodiments, one or more computer systems automatically produce content in response to a request for it. The content can be produced either off-device (e.g., by one or more nearby computer systems (such as accessible via a local network) and/or by one or more remote computers accessible (such as accessible via the internet)) or on-device (e.g., by a computer system at which the request is received). Text, audio, and/or visual elements (such as pictures, graphics, and/or video) are optionally included in the content.

In some embodiments, generative content refers to content generated by one or more artificial intelligence (AI) techniques (e.g., generative images, generative graphics, generative video, generative audio, and/or generative text). In such embodiment, an AI technique can generate the content in response to a stimulus that is given to it. In some embodiments, the AI technique incorporates one or more pre-processing techniques (e.g., adjustment to a user-provided prompt, development of a system-generated prompt, and/or AI model selection) before generating the content. In some embodiments, the AI technique incorporates one or more post-processing steps (e.g., passing the content to another AI technique, upscaling, downscaling, cropping, formatting, and/or adding or removing metadata) before the content is used for other purposes, such as being sent to another software process for additional processing or being presented to a user (e.g., visually or audibly).

One or more words (such as a spoken or written natural language prompt), one or more drawings, one or more images, and/or one or more videos can be included in a prompt for generating content. Examples of AI techniques include neural networks, transformer-based deep neural networks, large language models (LLMs), and generative pre-trained transformer models.

Although generative material is typically based on a prompt, it is created using the prompt as a starting point rather than being deterministically chosen from pre-generated content. In some embodiments, the prompt includes pre-existing content (such as text, audio, and/or visual content). For example, a prompt can ask for a block of text to be redone or summarized in a different tone. The result can be generative text that has been rewritten or summarized in the different tone. Similar to this, a prompt can ask for changes to visual content in order to include or exclude content that is specified by the prompt (e.g., deleting a feature that has been identified in visual content, adding a feature that is described in a prompt, altering a style of visual content, and/or producing additional visual elements that are based on visual content but are not located in the visual content). In some embodiments, the prompt includes or is used with a random or pseudo-random seed (e.g., content is generated using the random or pseudo-random seed as a starting point). For example, in order to create an image based on a diffusion model, a random noise pattern can be iteratively denoised on a basis of the prompt. Although this description has discussed particular kinds of AI techniques, it should be acknowledged that content can be generated by a wide range of AI techniques.

When gathering user data, organizations that share, collect, and/or use it should be transparent and/or have consent from users. Publicly accessible data can be used in certain techniques instead of in addition to user data. Data can be anonymized, aggregated, and/or processed in other ways to eliminate or restrict any individual identification in order to preserve user privacy. Entities that gather, distribute, and/or use such data in any way should have user consent before doing so and/or be transparent about the data collection process. Moreover, organizations in charge of user data, including but not restricted to data used in connection with AI techniques should make an effort to adhere to established privacy policies and/or privacy practices. When it comes to creating and/or training AI/ML systems, these organizations can adopt and continuously adhere to rules and procedures that are acknowledged as reaching or surpassing industry standards and legal requirements. While doing this, efforts should be made to guarantee that all privacy concerns and intellectual property rights are upheld. Practices for protecting training data, including private information, from abuse or exploitation should be incorporated into training. All phases of the creation, training, and application of AI/ML systems, including data collection, data preparation, model training, model evaluation, model deployment, and continuing monitoring and maintenance, should be covered by such policies and procedures. Accountability and transparency ought to be upheld at all times. Users should have easy access to such policies, which should be updated in response to changes in data collection and/or use. User information must be gathered for the entity’s reasonable and lawful purposes and not shared or sold for purposes other than those purposes. Furthermore, any gathering and sharing must to be transparent with users and/or only after obtaining their informed consent. Such organizations should also think about taking any necessary actions to protect and secure access to such data and make sure that those who have access to it follow their privacy policies and procedures. Additionally, such organizations ought to submit to third-party assessment in order to attest, if necessary for transparency, that they follow generally recognized privacy policies and procedures. Policies and/or practices should also be customized to a specific use case, applicable laws and standards, jurisdiction-specific factors, and the precise type of data being collected and/or accessed.

In some embodiments, AI/ML systems might make use of models that have been trained (for example, through supervised or unsupervised learning) utilizing a variety of training data, including information gathered from a user device. Such utilization of user-gathered data can be restricted to tasks performed on the user’s device. For instance, a model can be trained locally on the user’s device, preventing any data from being transferred to a different device. For another example, a model can be trained on one or more devices (e.g., a server) in addition to the user device, but this can be done in a way that protects privacy, like multi-party computation, which can be done cryptographically by secret sharing data or in another way that prevents user data from leaking to the other devices.

In certain implementations, such as federated learning, a model can be kept on several devices or centrally on the user’s device. Such decentralized storage can also be accomplished in a way that protects privacy, for example, by using cryptographic procedures that split each piece of data into shards that prevent the data from being reassembled or used by the user device alone or only in conjunction with another device or devices. In this way, a model can be trained and run using additional computational power of other devices, without exposing a user or device activity pattern. As a result, user-gathered data can be safeguarded. In certain implementations, a model can be trained by combining input from several devices in a way that protects privacy.

In some embodiments, the current disclosure assumes that information utilized by AI/ML systems can be kept completely distinct from platforms on which the AI/ML systems are installed, used to communicate with users, or used to process data. In these implementations, data used to train the AI/ML systems offline can be kept in restricted-access, secured datastores, and/or kept for no longer than is required for training. In certain implementations, the AI/ML systems can temporarily store data in a local memory cache while a user is interacting with them. The AI/ML systems’ performance can be enhanced by using the local memory cache. However, after the user session is over, data kept in the local memory cache can be deleted to preserve user privacy. After processing, any temporary data caches utilized for online learning or inference can be quickly deleted. Secure communication and/or industry-standard encryption should be used for all data collection, transfer, and/or storage.

As previously mentioned, in some embodiments, methods like homomorphic encryption, secure hardware components, federated learning, differential privacy, and/or multi-party computation can be used to further protect personal data while the AI/ML systems are being trained and/or used. Changes in the underlying data distribution, such as idea drift or data skew, should be watched for in AI/ML systems as they can eventually impair their performance. In some embodiments, both online and offline training are used to train the AI/ML systems. While online training enables AI/ML systems to continuously adapt and/or improve, offline training can use carefully selected datasets to set baseline model performance. The current disclosure acknowledges how crucial it is to uphold stringent data governance procedures during this procedure in order to guarantee user privacy. In some embodiments, the AI/ML systems might be built with protections to ensure that they stay true to their initial goals even as they change in response to fresh data. Any significant adjustments to the way an AI/ML system collects and/or uses data can (and in certain situations should) be openly shared with the relevant parties. This can involve getting user consent for any changes to the way user data is gathered and/or used.

The current disclosure additionally considers examples where users can block or selectively restrict access to and/or use of data. In other words, the current disclosure assumes that components of software and/or hardware can be offered to restrict or stop data access. For certain services, for instance, the current technology should be set up to provide customers the option to “opt in” or “opt out” of taking part in data collecting at the time-of-service registration or at any point subsequently. As an additional illustration, current technology ought to be set up to let users choose not to supply specific data for AI/ML system training or for usage as input when the systems are in the inference stage. Another example is that current technology should be set up to give customers the option to restrict how long their data is kept or to completely forbid AI/ML systems from using their data. The current disclosure involves sending alerts regarding the access or use of personal information in addition to offering “opt in” and “opt out” options. A user can be reminded when the AI/ML systems produce outputs or make judgments based on their data, for example, or they can receive notifications when their data is being entered into the systems for training or inference.

The current disclosure acknowledges that, even when AI/ML systems are developed, constructed, and/or operated in accordance with industry best practices and standards, they should have clear limitations and/or oversight to reduce potential hazards. For instance, outputs that might be deemed inaccurate, damaging, offensive, and/or biased might be generated; these outputs might not accurately represent the views or stances of the organizations creating or implementing these systems. Additionally, in certain situations, mentions of third-party goods and/or services in the outputs should not be interpreted as affiliations or endorsements by the companies who supply the AI/ML systems. Human oversight and/or the capacity to override or fix incorrect or undesirable outputs can be maintained as a failsafe, and generated content can be checked for potentially unsuitable or dangerous material before being shown to users.

The current disclosure also takes into consideration that users of the AI/ML systems should not use the services in any way that violates, infringes upon, or misappropriates the rights of any other party. Additionally, the AI/ML systems should not be utilized for any illegal or unlawful conduct, nor should they be used to create any use cases or applications that would commit or assist in the commission of any criminal, tortious, or illegal act. The AI/ML systems must properly attribute content as needed and not infringe upon, violate, or misappropriate any copyrights, trademarks, rights of privacy and publicity, trade secrets, patents, or other property or legal rights of any party. Furthermore, no security, digital signing, digital rights management, content protection, verification, or authentication process should be hampered by AI/ML systems. Machine-generated outputs should not be mistakenly represented as human-generated by AI/ML systems.

Using and/or collecting data from several sources is one aspect of the technology mentioned above. Such information can be utilized to enhance a device’s interactions with its surroundings, such as those with users. Personal information that can be used to uniquely identify an individual can be included in such data in certain situations. Demographic information, phone numbers, email addresses, location and/or location-related information, home, and work addresses, and/or any other identifying information can all be considered personal information. Users of the device can benefit from the use of such personal information. For instance, a user’s personal data can be utilized to enhance the device’s communication with the user. Within the parameters of the current disclosure, additional advantages can potentially arise from the usage of personal data.

One or more entities can need to handle personal data in order for it to be used. These organizations can be engaged in gathering, processing, revealing, moving, storing, or performing other tasks that facilitate the technologies covered here. Although it does not prevent it, the current disclosure assumes that all uses of personal identifiable data adhere to existing privacy rules and/or procedures of such entities. Generally speaking, such policies and practices must adhere to all relevant legislative regulations pertaining to data privacy and security, as well as reach or beyond widely accepted industry standards. For instance, businesses should obtain users’ informed consent before collecting and using personal data, and they should only do so for appropriate and justifiable purposes. Furthermore, a user’s personal information should never be sold, transferred, divulged, or used for purposes other than those that are reasonable and/or lawful.

There are a number of situations where personal data is unavailable, such as when a user decides not to disclose it. The user can, for instance, “opt out” of sharing such data or not specifically “opt in” during the registration process to refuse consent for the gathering and/or use of such data. Any number of other hardware and/or software components that prohibit the gathering and/or use of such data can also be used by the user. The current disclosure considers that implementations of the current technology can be used without such data, even though the usage of personal information can benefit a user by improving the device’s performance. For instance, the device’s functions can make use of non-personal data (for instance, in lieu of or in addition to personal data). Other methods involve drawing conclusions from data that does not contain personal information or from a small amount of personal information.

What is claimed is:

1. A method, comprising:
at a computer system:
receiving a request to output first content on a set of one or more devices; and
in response to receiving the request to output the first content on the set of one or more devices:
in accordance with a determination that a first device of the set of one or more devices satisfies a set of one or more criteria with respect to output of the first content, causing the first device of the set of one or more devices to output second content related to the first content; and
in accordance with a determination that a second device of the set of one or more devices satisfies the set of one or more criteria with respect to output of the first content, causing the second device of the set of one or more devices to output the second content related to the first content, wherein the first device is different from the second device.

2. The method of claim 1, wherein the determination that the first device of the set of one or more devices satisfies the set of one or more criteria with respect to output of the first content includes a determination that the content includes audio content.

3. The method of claim 1, wherein the determination that the first device satisfies the set of one or more criteria with respect to output of the first content includes a determination that the content includes visual content.

4. The method of claim 1, wherein the determination that the first device satisfies the set of one or more criteria with respect to output of the first content includes a determination that the first content includes audio content and visual content.

5. The method of claim 1, wherein the determination that the first device satisfies the set of one or more criteria with respect to output of the first content includes a determination that a subject is positioned in front of the first device.

6. The method of claim 1, wherein the determination that the first device satisfies the set of one or more criteria with respect to output of the first content includes a determination that the current time is a specific time.

7. The method of claim 1, wherein the determination that the first device satisfies the set of one or more criteria with respect to output of the first content includes a determination that the request corresponds to a first individual.

8. The method of claim 1, wherein the determination that the first device satisfies the set of one or more criteria with respect to output of the first content includes a determination that the first device corresponds to a first individual.

9. The method of claim 1, wherein causing the first device of the set of one or more devices to output the second content related to the first content includes causing display of a notification.

10. The method of claim 1, further comprising:
in response to receiving the request to output the first content on the set of one or more devices and in accordance with the determination that the first device of the set of one or more devices satisfies the set of one or more criteria with respect to output of the first content, forgoing causing the second device of the set of one or more devices to output the second content related to the first content.

11. The method of claim 1, wherein the set of one or more devices are positioned within an environment.

12. The method of claim 1, wherein the first device outputs third content before receiving the request to output the first content on the set of one or more devices, and wherein causing the first device of the set of one or more devices to output the second content related to the first content includes causing the first device to cease output of the third content.

13. The method of claim 1, wherein:
the first device displays third content while the computer system receives the request to output the first content on the set of one or more devices; and
causing the first device of the set of one or more devices to output the second content includes causing the first device of the set of one or more devices to output the second content overlaid on the third content.

14. The method of claim 1, further comprising:
in response to receiving the request to output the first content on the set of one or more devices:
in accordance with the determination that the first device of the set of one or more devices satisfies the set of one or more criteria with respect to output of the first content, forgoing causing a third device of the set of one or more devices to output the second content related to the first content, wherein the third device is separate from the first device and the second device; and
in accordance with the determination that the second device of the set of one or more devices satisfies the set of one or more criteria with respect to output of the first content, forgoing causing the third device of the set of one or more devices to output the second content related to the first content.

15. The method of claim 1, further comprising:
in response to receiving the request to output the first content on the set of one or more devices and in accordance with a determination that the first device and the second device of the set of one or more devices do not satisfy the set of one or more criteria, forgoing causing the second device and the first device from outputting the second content related to the first content.

16. The method of claim 1, wherein causing the first device of the set of one or more devices to output the second content includes causing the first device to output the second content in a first modality and a second modality, wherein the second modality is different from the first modality.

17. The method of claim 1, wherein the second content is the first content.

18. A non-transitory computer-readable storage medium storing one or more programs configured to be executed by one or more processors of a computer system, the one or more programs including instructions for:
receiving a request to output first content on a set of one or more devices; and
in response to receiving the request to output the first content on the set of one or more devices:
in accordance with a determination that a first device of the set of one or more devices satisfies a set of one or more criteria with respect to output of the first content, causing the first device of the set of one or more devices to output second content related to the first content; and
in accordance with a determination that a second device of the set of one or more devices satisfies the set of one or more criteria with respect to output of the first content, causing the second device of the set of one or more devices to output the second content related to the first content, wherein the first device is different from the second device.

19. A computer system, comprising:
one or more processors; and
memory storing one or more programs configured to be executed by the one or more processors, the one or more programs including instructions for:
receiving a request to output first content on a set of one or more devices; and
in response to receiving the request to output the first content on the set of one or more devices:
in accordance with a determination that a first device of the set of one or more devices satisfies a set of one or more criteria with respect to output of the first content, causing the first device of the set of one or more devices to output second content related to the first content; and
in accordance with a determination that a second device of the set of one or more devices satisfies the set of one or more criteria with respect to output of the first content, causing the second device of the set of one or more devices to output the second content related to the first content, wherein the first device is different from the second device.
